(19) United States
(12) Patent Application Publication
(10) Pub. No.: US 2016/0104178 A1
(43) Pub. Date: Apr. 14, 2016

(54) SYSTEMS AND METHODS FOR TRACKING AND INCENTIVIZING BRAND, CATEGORY, AND/OR INDUSTRY EXPERTISE

(71) Applicant: Thomas G. Stockham, Holladay, UT (US)

(72) Inventor: Thomas G. Stockham, Holladay, UT (US)

(21) Appl. No.: 14/514,229

(22) Filed: Oct. 14, 2014

(51) Int. Cl. G06Q 30/02; H04W 4/02; G07C 13/00

(52) U.S. Cl. CPC G06Q 30/0203; G07C 13/00; H04W 4/021

(57) ABSTRACT

Individuals who are interested in products and/or areas of expertise and who have a certain influence with others in that area of expertise are incentivized to increase their awareness of an knowledge of that area of expertise as well as the manufacturers' products within that area of expertise through various activities. Activities that are incentivized may include gaining information about products and brands through participating in or consuming training materials, by purchasing or otherwise owning the products and brands, through experience, and the like. As the individuals gain knowledge about the area of expertise, the brands, and the products, the individuals gain influence and ability to inform others about the brands and products and their features and benefits. The manufacturers benefit because they now have a large number of individuals able to act on the manufacturers' behalf in informing others of the features and benefits of the manufacturers' products.

### BACKGROUND OF THE INVENTION

1. Field of the Invention

The present invention relates to brand, category, and/or industry expertise, and more particularly to systems and methods for tracking and incentivizing increases in brand, category, and/or industry expertise.

2. Background and Related Art

Manufacturers of products in a variety of fields have long sought to increase customers' awareness of their products and their brands. In many instances, customers may be unaware of a brand, or of the benefits that can be obtained through use of the manufacturer's products. Indeed, the expectation is often that increasing customer awareness of brands, products, product benefits, and the like would result in increased demand for and sales of the products.

Manufacturers have utilized different mechanisms to increase consumers' awareness of the brands and their products, with varying success. For example, television and radio commercials have long been used to expose consumers to brands and their products and to inform consumers about the products. Print advertisements have been in use for an even longer period of time. There are, however, certain limitations on the efficacy of commercial advertising of these types. Typically, despite advertisers' best efforts, various forms of advertising have been difficult to accurately target to desired consumers, and advertising money is therefore often spent on advertisements that reach unintended audiences, that fail to reach intended audiences, or that only partially reach desired audiences. Furthermore, the resulting action or lack of action by the captured audience as a result of the advertisements is not trackable or is at least difficult to track. Additionally, advertisements are limited in their ability to convey information about brands and their products. A manufacturer is limited in the amount of information that can be accurately conveyed in a thirty-second television spot, for example, and the cost of such advertising may reduce the return on investment for attempts to convey more information, such as by additional or by longer television commercials. Indeed, advertising costs are a concern with many types of traditional advertising.

With the advent and spread of the Internet, additional methods of advertising and of conveying information to consumers have become available. Manufacturers are now able to create their own websites, often with significant amounts of information about their products. When a manufacturer creates new products, it can easily update its website to include information about the new products. Additionally, there are now multiple methods for advertising over the Internet, such as by purchasing sponsored-link status in association with certain Internet keyword searches on major Internet search providers, by purchasing banner advertisements on others' web pages, and the like. Unfortunately, despite nearly constant improvements in current methods of Internet advertising and the targeting thereof, problems still remain. Many Internet users simply ignore much of the Internet advertising directed at them. Studies have proven that consumers today generally distrust information directly from a manufacturer and at a minimum trust personal recommendations at a much higher rate. Additionally, unless a consumer actively seeks out a manufacturer's webpage or other information source to inform him or herself about products, the new Internet advertising methods still suffer from an inability to convey much information about a brand or its products.

Due to these limitations, manufacturers often seek to establish brand and product awareness through the efforts of influential individuals. For example, manufacturers may sponsor prominent individuals in various fields (e.g. prominent athletes in various athletic endeavors), who then promote the manufacturer's products while participating in their various fields. Manufacturers may also hire well-known individuals such as celebrities to promote their products and act as a spokesperson for or as the “face” of the manufacturer or product line. In effect, the manufacturers attempt to utilize the well-known status of others or the exposure of others to create a link in the mind of the consuming public that will cause the public to become more aware of and more likely to buy the manufacturer's products. Unfortunately, while such efforts undoubtedly lead to increased awareness and sales, such efforts rarely result in significant increases in consumers' knowledge about the features and benefits associated with the manufacturer's products and brands.

In short, manufacturers continue to suffer from an inability to effectively reach consumers that would be potentially interested in their products and to then inform such consumers about their products, their features and benefits, and other information that could lead to such consumers becoming customers of the manufacturers' products.

### BRIEF SUMMARY OF THE INVENTION

Implementations of the invention provide benefits to manufacturers not realized by existing systems and methods. Systems and practices in accordance with implementations of the invention utilize direct contact with individuals who are interested in products and/or areas of expertise and who have a certain influence with others in that area of expertise. The areas of expertise may include brand expertise, industry expertise, manufacturer expertise, category expertise, and the like. Then, those individuals are incentivized to increase their awareness and knowledge of that area of expertise as well as the manufacturers' products within that area of expertise through various activities. Activities that are incentivized may include gaining information about products and brands through participating in or consuming training materials, gaining information about products and brands by purchasing or otherwise owning the products and brands, gaining information about the area of expertise through experience, and the like. As the individuals gain knowledge about the area of expertise, the brands, and the products, the individuals gain influence and ability to inform others about the brands and products and their features and benefits. The manufacturers benefit because they now have a large number of individuals able to act on the manufacturers' behalf in informing others of the features and benefits of the manufacturers' products and to otherwise positively influence demand for and sales of their products. Consumers are benefitted in that they are provided increased access to individuals who have become experts in their field or fields and who can properly inform them of the products, features, and benefits they should look for when making purchasing decisions.

The manufacturers of the brands and products are able to incentivize the individuals through a system that receives and tracks information about the individuals' knowledge, experience, product ownership, and helpfulness, and any other information that may be helpful in evaluating the individuals' influence. The system also provides a convenient mechanism for the manufacturers to provide training materials to the individuals. To maximize the individuals' willingness and desire to participate in the system and improve their influence rating, the system may be provided free of charge to the individuals, with revenue being earned from the manufacturers as the individuals complete training, own product, gain industry or other relevant experience, or other benchmarks agreed to, provided by or established by the manufacturers. The system may also incentivize participation by displaying individuals' progress within benchmarks established by the system. Additionally, the individuals may be incentivized to participate in the system through comparative means such as by displaying to the individuals information relating to where they fall in a hierarchy of expertise, such as in the top five percent or ten percent of participants in the system (or any other desirable comparative benchmark) so as to incentivize participation through competitive means.

Accordingly, implementations of the invention may utilize or provide systems, methods, and computer-readable media containing computer-executable instructions to provide systems or methods for tracking and incentivizing improvements in individuals' category, industry, and/or brand expertise. An exemplary method in accordance with implementations of the invention includes steps of receiving and storing data evidencing an individual's knowledge of products in an area of expertise, receiving and storing data evidencing the individual's ownership of or familiarity with products in the area of expertise, receiving and storing data evidencing the individual's experience in the area of expertise, and receiving and storing indicia of the individual's helpfulness received from one or more persons other than the individual.

According to the method, the system then utilizes the data evidencing the individual's knowledge of products in the area of expertise, the data evidencing the individual's ownership of or familiarity with products in the area of expertise, the data evidencing the individual's experience in the area of expertise, and the indicia of the individual's helpfulness to generate a score and/or hierarchy of the individual's influence in the area of expertise. The score and/or hierarchy of the individual's influence in the area of expertise may be used to match the individual with a person or entity such as a manufacturer of products in the area of expertise, a brand of products in the area of expertise, a retailer selling products in the area of expertise, and a consumer seeking guidance or advice in the area of expertise. Alternatively, the score and/or hierarchy of the individual's influence in the area of expertise may be used to match the individual with a consumer seeking information or products relating to the area of expertise.

The area of expertise may be any desirable area of expertise. For example, areas of expertise may include any of a variety of areas of competitive and non-competitive team and individual sports expertise, such as football, basketball, rugby, tennis, racquetball, baseball, cricket, track-and-field sports, swimming, diving, scuba diving, water skiing, wakeboarding, and other water sports, skiing, snowboarding, and other snow sports, skating, ultimate Frisbee, golfing, running, jogging, surfing, triathlon, biking, power sports, shooting and tactical, and the like. Areas of expertise may also include any of a variety of technical or similar areas of expertise, such as automotive performance, electronics, woodworking, building or any component thereof (e.g. plumbing, electrical, tiling, etc.), computers, and the like. Areas of expertise may also include a variety of outdoor activities, such as hiking, backpacking, fishing, boating, climbing, snow shoeing, bird watching, ballooning, skydiving, hang gliding, parasailing, sailing, mountain biking, archery, hunting, and the like. Areas of expertise may also include a variety of areas relating to self-improvement or health, such as nutrition, beauty, fashion, fitness and training, health and wellness, personal finance, travel, and the like. Areas of expertise may include any other area of expertise that may be of interest to individuals and/or manufacturers, and manufacturers may even suggest or establish areas of expertise relating to their products. Non-limiting examples of other areas of expertise include animals and pets, footwear, clothing, housewares, safety and rescue, and the like. Areas of expertise may also include certain types of products and/or products of a certain brand. The foregoing list of areas of expertise is intended to be illustrative only, and other areas of expertise are embraced by implementations of the invention even though not specifically mentioned herein.

Generating a score and/or hierarchy of the individual's influence in the area of expertise may involve applying a decay algorithm to deemphasize a component of the score and/or hierarchy of the individual's influence of the individual's knowledge, product ownership, experience, or helpfulness as time passes. The decay algorithm may include a logarithmic component of decay. Alternatively, the decay algorithm may include an alternative decay function such as linear decay, exponential decay, all-at-once decay (no decay for a period of time followed by complete removal), stepped decay, a combination of two or more types of decay, or any other form of decay. Furthermore, generating a score and/or hierarchy of the individual's influence in the area of expertise may also or alternatively include eliminating a component of the score and/or hierarchy of the individual's influence of the individual's knowledge, product ownership, experience, or helpfulness as time passes. For example, an individual may gain a component of his or her score and/or hierarchy by completing a training module provided by the manufacturer relating to features and benefits of certain of the manufacturer's products in or related to an area of expertise. In recognition of the fact that knowledge gained through training may fade with time, however, or may become obsolete with the passage of time, the system may deemphasize or eliminate the score and/or hierarchy component as time passes. The individual may be able to recover the score and/or hierarchy component by completing the training module again (e.g. refreshing the training), by re-taking and passing a quiz or other evaluation associated with the previous training, or by completing a new training module such as one replacing the previous training module.

Receiving and storing data evidencing the individual's knowledge of products in the area of expertise may include administering a quiz to test the individual's knowledge of products in the area of expertise and upon completion of the quiz with a satisfactory score, assigning points toward the score and/or hierarchy of the individual's influence in the area of expertise based on completion of the quiz. Additionally or alternatively, receiving and storing data evidencing the individual's knowledge of products in the area of expertise may include receiving a selection from the individual indicating a desire to review a training module relating to the products in the area of expertise, delivering the training module relating to the products in the area of expertise to the individual over a network, and administering a quiz over the network to confirm that the individual has understood information presented in the training module.

The training module may be received from a manufacturer of products in the area of expertise. Alternatively, the training module may be created by someone other than the manufacturer using information provided by the manufacturer. The training module may be created based on best practices in the areas of e-learning or adult e-learing. The manufacturer or other provider of the training module may also assign training points for the training module in at least the area of expertise to be granted to the individual upon successful completion of the training module. In some instances, a training module may be relevant to multiple areas of expertise, and the manufacturer may assign training points to multiple areas of expertise accordingly. The system may track all users who complete viewing of the training module and bill the manufacturer for all instances of completion of the training module.

One or more of the acts of receiving data may include automatically obtaining data from an external data source over a network. Examples of external data sources include a social media account of the individual, a social media website associated with the individual, a social media application of the individual, a global positioning system (GPS) application associated with the individual, a GPS device associated with the individual, a fitness tracking application associated with the individual, a fitness tracking device associated with the individual, a fitness website containing information relating to the individual, a website containing a profile of the individual with relevant information, a website containing information relating to tracking activity of the individual, a website containing information relating to professional expertise of the individual, a website or third party that provided relevant training content to the individual, a website containing information relating to results of competitive events for the individual, a purchase history of relevant products for the individual, a website or multiple websites with relevant content created by the individual, and the like.

The score and/or hierarchy of the individual's influence in the area of expertise may at times be more heavily weighted toward one or more of the aspects of knowledge of products, ownership of or familiarity with products, experience, and helpfulness. Alternatively, the score and/or hierarchy of the individual's influence in the area of expertise is evenly weighted toward all of the aspects of knowledge of products, ownership of or familiarity with products, experience, and helpfulness.

Receiving and storing data evidencing the individual's ownership of or familiarity with products in the area of expertise may include receiving information relating to purchases of the products through the system. Thus, receiving and storing data evidencing the individual's ownership of or familiarity with products in the area of expertise may include receiving an order from the individual to purchase a product through a site operated by the computer system and adding the product to a profile of the individual on the computer system. Alternative, receiving and storing data evidencing the individual's ownership of or familiarity with products in the area of expertise may include steps to allow the individual to indicate ownership of or familiarity with products not purchased through the system. Thus, receiving and storing data evidencing the individual's ownership of or familiarity with products in the area of expertise may include displaying products related to the area of expertise to the individual, receiving an indication from the individual that the individual owns or is familiar with one of the products displayed to the individual, and adding the product to a profile of the individual on the computer system.

Methods according to implementations of the invention may also include receiving information from the individual to create a profile associated with the individual, displaying the profile to other users of the computer system while providing an opportunity for the other users to vote the profile up or down, and receiving and storing one or more up or down votes from the other users, the up or down votes being used to adjust the score and/or hierarchy of the individual's influence in the area of expertise. In this fashion, the system is able to receive additional inputs measuring the influence of the individual in the area of expertise. Alternatively, methods according to implementations of the invention may also include receiving information from the individual to create a profile associated with the individual, and displaying the individual's progress within benchmarks and hierarchies established in the computer system to incentivize participation in the system through competitive means.

Similarly, methods according to implementations of the invention may also include providing a question and answer forum related to the area of expertise, receiving a question from one or more other users of the computer system relating to the area of expertise and displaying the question to the individual. The system then is able to receive a response to the question from the individual, and displays the individual's response to one or more other users of the question and answer forum while providing an opportunity for the other users to vote the individual's response up or down. The system then receives and stores one or more up or down votes from the other users, the up or down votes being used to adjust the score and/or hierarchy of the individual's influence in the area of expertise. In this fashion, the system is also able to receive additional inputs measuring the influence of the individual in the area of expertise.

In accordance with certain implementations of the invention, the system receives a request from another user of the computer system to identify an expert in the area of expertise and uses the score and/or hierarchy of the individual's influence in the area of expertise to identify the individual as an expert in the area of expertise to the other user. Similarly, the system may use the score and/or hierarchy of the individual's influence in the area of expertise to provide an expert locator functionality allowing other users of the computer system to identify individuals geographically local to them with expertise in the area of expertise. The expert locator functionality need not necessarily be limited to locating geographically proximate experts, but may be used in any desirable fashion to connect consumers with individuals having a desired level of expertise in a desired area of expertise. According to implementations of the invention, manufacturers of products in an area of expertise are notified of the individual's score and/or hierarchy of the individual's influence, and the system provides a communications platform for communications by the manufacturer to the individual.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computer system for use in conjunction with embodiments of the invention;

FIG. 2 shows a representative networked computer system for use in conjunction with embodiments of the invention;

FIG. 3 shows a view of a representative web browser; and

FIGS. 4-30 show illustrative screenshots of webpages illustrating features of embodiments of the invention.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide benefits to manufacturers not realized by existing systems and methods. Systems and practices in accordance with embodiments of the invention utilize direct contact with individuals who are interested in products and/or areas of expertise and who have a certain influence with others in that area of expertise. Then, those individuals are incentivized to increase their awareness and knowledge of that area of expertise as well as the manufacturers' products within that area of expertise through various activities. Activities that are incentivized may include gaining information about products and brands through participating in or consuming training materials, gaining information about products and brands by purchasing or otherwise owning the products and brands, gaining information about the area of expertise through experience, and the like. As the individuals gain knowledge about the area of expertise, the brands, and the products, the individuals gain influence and ability to inform others about the brands and products and their features and benefits. The manufacturers benefit because they now have a large number of individuals able to act on the manufacturers' behalf in informing others of the features and benefits of the manufacturers' products and to otherwise positively influence demand for and sales of their products. Consumers are benefitted in that they are provided increased access to individuals who have become experts in their field or fields and who can properly inform them of the products, features, and benefits they should look for when making purchasing decisions.

The manufacturers or sellers of the brands and products are able to incentivize the individuals through a system that receives and tracks information about the individuals' knowledge, experience, product ownership, and helpfulness, and any other information that may be helpful in evaluating the individuals' influence. The system also provides a convenient mechanism for the manufacturers to provide training materials to the individuals. To maximize the individuals' willingness and desire to participate in the system and improve their influence rating, the system may be provided free of charge to the individuals, with revenue being earned from the manufacturers as the individuals complete training, own product, gain industry or other relevant experience, or other benchmarks agreed to, provided by or established by the manufacturers. The system may also incentivize participation by displaying individuals' progress within benchmarks established by the system. Additionally, the individuals may be incentivized to participate in the system through comparative means such as by displaying to the individuals information relating to where they fall in a hierarchy of expertise, such as in the top five percent or ten percent of participants in the system (or any other desirable comparative benchmark) so as to incentivize participation through competitive means.

Accordingly, embodiments of the invention may utilize or provide systems, methods, and computer-readable media containing computer-executable instructions to provide systems or methods for tracking and incentivizing improvements in individuals' category, industry, and/or brand expertise. An exemplary method in accordance with embodiments of the invention includes steps of receiving and storing data evidencing an individual's knowledge of products or other information in an area of expertise, receiving and storing data evidencing the individual's ownership of or familiarity with products in the area of expertise, receiving and storing data evidencing the individual's experience in the area of expertise, and receiving and storing indicia of the individual's helpfulness received from one or more persons other than the individual.

The information in the area of expertise that the individual knows may be any type of knowledge obtained via any type of learning event. For example, individuals can learn knowledge by reading instructive or other materials, by watching instructive or other materials, by listening to instructive or other materials, and the like. Alternatively, individuals can learn knowledge through experience. Often, but not always, individuals' knowledge about an area of expertise and competency therein may be established using testing or the like. Alternatively, information may be received from third parties (e.g. an employer, some other third party who has experience with the individual's level of knowledge/expertise, etc.) about the individual's knowledge and/or expertise. In some instances, consumption of instructional/training materials may be equated with knowledge, and any type of tool that permits tracking of consumption may be used to track and evaluate knowledge, such as tools that track the online content consumed (the tools currently used in advertisement re-targeting online are an example). Alternatively, learning obtained from traditional teaching institutions may be recognized by the system, such as information relating to degrees or certifications from a university, vocational school, a certifying organization, or the like. Some evaluation of knowledge may be obtained directly from interactions with other knowledgeable individuals.

The system also may utilize information relating to products owned by the individual or with which the individual is sufficiently familiar. In some instances, the system may require ownership of the products. In some such instances and to prevent individuals from falsifying the information relating to their ownership, the system may only take into account products purchased through the system. Alternatively, the system may allow the individual to self-identify products owned by the individual. In still other instances, ownership may not be required, but the system may require some level of familiarity with a product, such as through past ownership, rental use of the product, or other sufficient use of the product to establish sufficient familiarity with the product. For example, the system could pose certain questions about the product to the individual to verify the individual's familiarity with the product.

An individual's experience in an area of expertise may include a broad range of activities that could be tracked by the system relating to the individual's level of experience. Relevant information may include the individual's profession or professions, the individual's hobby or hobbies, events the individual participates in, competitions entered by the individual, any other indicia of the manner in which the individual spends his or her time, and the like. Such information may include information received from a variety of sources, such as tracking devices, programs, and websites, competition and activity records (e.g. marathon results pages, other race results sites, etc.), and the like.

The indicia of the individual's helpfulness may include one or more of reviews of the individual's helpfulness from third parties, indications that individual successfully assisted one or more consumers with questions of the consumer(s), indications of being available in a store or other retail establishment, indications of being available on site at a non-store location (e.g. on a ski hill, at a resort, at a gun range, etc.), indications of being available online, indications of being available at home, indications of having written helpful blogs, indications of writing articles for category magazines or other press, and the like. The indicia of the individual's helpfulness may also incorporate measures of the individual's influence, such as may be measured by how others responded to the advice or information provided by the individual.

According to the method, the system then utilizes the data evidencing the individual's knowledge of products in the area of expertise, the data evidencing the individual's ownership of or familiarity with products in the area of expertise, the data evidencing the individual's experience in the area of expertise, and the indicia of the individual's helpfulness to generate a score and/or hierarchy of the individual's influence in the area of expertise. The score and/or hierarchy of the individual's influence in the area of expertise may be used to match the individual with a person or entity such as a manufacturer of products in the area of expertise, a brand of products in the area of expertise, a retailer selling products in the area of expertise, and a consumer seeking guidance or advice in the area of expertise. Alternatively, the score and/or hierarchy of the individual's influence in the area of expertise may be used to match the individual with a consumer seeking information or products relating to the area of expertise.

The area of expertise may be any desirable area of expertise. For example, areas of expertise may include any of a variety of areas of competitive and non-competitive team and individual sports expertise, such as football, basketball, rugby, tennis, racquetball, baseball, cricket, track-and-field sports, swimming, diving, scuba diving, water skiing, wakeboarding, and other water sports, skiing, snowboarding, and other snow sports, skating, ultimate Frisbee, golfing, running, jogging, surfing, triathlon, biking, power sports, shooting and tactical, and the like. Areas of expertise may also include any of a variety of technical or similar areas of expertise, such as automotive performance, electronics, woodworking, building or any component thereof (e.g. plumbing, electrical, tiling, etc.), computers, and the like. Areas of expertise may also include a variety of outdoor activities, such as hiking, backpacking, fishing, boating, climbing, snow shoeing, bird watching, ballooning, skydiving, hang gliding, parasailing, sailing, mountain biking, archery, hunting, and the like. Areas of expertise may also include a variety of areas relating to self-improvement or health, such as nutrition, beauty, fashion, fitness and training, health and wellness, personal finance, travel, and the like. Areas of expertise may include any other area of expertise that may be of interest to individuals and/or manufacturers, and manufacturers may even suggest or establish areas of expertise relating to their products. Non-limiting examples of other areas of expertise include animals and pets, footwear, clothing, housewares, safety and rescue, and the like. Areas of expertise may also include certain types of products and/or products of a certain brand. The foregoing list of areas of expertise is intended to be illustrative only, and other areas of expertise are embraced by embodiments of the invention even though not specifically mentioned herein.

Generating a score and/or hierarchy of the individual's influence in the area of expertise may involve applying a decay algorithm to deemphasize a component of the score and/or hierarchy of the individual's influence of the individual's knowledge, product ownership, experience, or helpfulness as time passes. The decay algorithm may include a logarithmic component of decay. Alternatively, the decay algorithm may include an alternative decay function such as linear decay, exponential decay, all-at-once decay (no decay for a period of time followed by complete removal), stepped decay, a combination of two or more types of decay, or any other form of decay. Furthermore, generating a score and/or hierarchy of the individual's influence in the area of expertise may also or alternatively include eliminating a component of the score and/or hierarchy of the individual's influence of the individual's knowledge, product ownership, experience, or helpfulness as time passes. For example, an individual may gain a component of his or her score and/or hierarchy by completing a training module provided by the manufacturer relating to features and benefits of certain of the manufacturer's products in or related to an area of expertise. In recognition of the fact that knowledge gained through training may fade with time, however, or may become obsolete with the passage of time, the system may deemphasize or eliminate the score and/or hierarchy component as time passes. The individual may be able to recover the score and/or hierarchy component by completing the training module again (e.g. refreshing the training), by re-taking and passing a quiz or other evaluation associated with the previous training, or by completing a new training module such as one replacing the previous training module.

Receiving and storing data evidencing the individual's knowledge of products in the area of expertise may include administering a quiz to test the individual's knowledge of products in the area of expertise and upon completion of the quiz with a satisfactory score, assigning points toward the score and/or hierarchy of the individual's influence in the area of expertise based on completion of the quiz. Additionally or alternatively, receiving and storing data evidencing the individual's knowledge of products in the area of expertise may include receiving a selection from the individual indicating a desire to review a training module relating to the products in the area of expertise, delivering the training module relating to the products in the area of expertise to the individual over a network, and administering a quiz over the network to confirm that the individual has understood information presented in the training module.

The training module may be received from a manufacturer of products in the area of expertise. Alternatively, the training module may be created by someone other than the manufacturer using information provided by the manufacturer. The training module may be created based on best practices in the areas of e-learning or adult e-learing. The manufacturer or other provider of the training module may also assign training points for the training module in at least the area of expertise to be granted to the individual upon successful completion of the training module. In some instances, a training module may be relevant to multiple areas of expertise, and the manufacturer may assign training points to multiple areas of expertise accordingly. The system may track all users who complete viewing of the training module and bill the manufacturer for all instances of completion of the training module.

One or more of the acts of receiving data may include automatically obtaining data from an external data source over a network. Examples of external data sources include a social media account of the individual, a social media website associated with the individual, a social media application of the individual, a global positioning system (GPS) application associated with the individual, a GPS device associated with the individual, a fitness tracking application associated with the individual, a fitness tracking device associated with the individual, a fitness website containing information relating to the individual, a website containing a profile of the individual with relevant information, a website containing information relating to tracking activity of the individual, a website containing information relating to professional expertise of the individual, a website or third party that provided relevant training content to the individual, a website containing information relating to results of competitive events for the individual, a purchase history of relevant products for the individual, a website or multiple websites with relevant content created by the individual, and the like.

The score and/or hierarchy of the individual's influence in the area of expertise may at times be more heavily weighted toward one or more of the aspects of knowledge of products, ownership of or familiarity with products, experience, and helpfulness. Alternatively, the score and/or hierarchy of the individual's influence in the area of expertise is evenly weighted toward all of the aspects of knowledge of products, ownership of or familiarity with products, experience, and helpfulness.

Receiving and storing data evidencing the individual's ownership of or familiarity with products in the area of expertise may include receiving information relating to purchases of the products through the system. Thus, receiving and storing data evidencing the individual's ownership of or familiarity with products in the area of expertise may include receiving an order from the individual to purchase a product through a site operated by the computer system and adding the product to a profile of the individual on the computer system. Alternative, receiving and storing data evidencing the individual's ownership of or familiarity with products in the area of expertise may include steps to allow the individual to indicate ownership of or familiarity with products not purchased through the system. Thus, receiving and storing data evidencing the individual's ownership of or familiarity with products in the area of expertise may include displaying products related to the area of expertise to the individual, receiving an indication from the individual that the individual owns one of the products displayed to the individual, and adding the product to a profile of the individual on the computer system.

Methods according to embodiments of the invention may also include receiving information from the individual to create a profile associated with the individual, displaying the profile to other users of the computer system while providing an opportunity for the other users to vote the profile up or down, and receiving and storing one or more up or down votes from the other users, the up or down votes being used to adjust the score and/or hierarchy of the individual's influence in the area of expertise. In this fashion, the system is able to receive additional inputs measuring the influence of the individual in the area of expertise. Alternatively, methods according to implementations of the invention may also include receiving information from the individual to create a profile associated with the individual, and displaying the individual's progress within benchmarks and hierarchies established in the computer system to incentivize participation in the system through competitive means.

Similarly, methods according to embodiments of the invention may also include providing a question and answer forum related to the area of expertise, receiving a question from one or more other users of the computer system relating to the area of expertise and displaying the question to the individual. The system then is able to receive a response to the question from the individual, and displays the individual's response to one or more other users of the question and answer forum while providing an opportunity for the other users to vote the individual's response up or down. The system then receives and stores one or more up or down votes from the other users, the up or down votes being used to adjust the score and/or hierarchy of the individual's influence in the area of expertise. In this fashion, the system is also able to receive additional inputs measuring the influence of the individual in the area of expertise.

In accordance with certain embodiments of the invention, the system receives a request from another user of the computer system to identify an expert in the area of expertise and uses the score and/or hierarchy of the individual's influence in the area of expertise to identify the individual as an expert in the area of expertise to the other user. Similarly, the system may use the score and/or hierarchy of the individual's influence in the area of expertise to provide an expert locator functionality allowing other users of the computer system to identify individuals geographically local to them with expertise in the area of expertise. The expert locator functionality need not necessarily be limited to locating geographically proximate experts, but may be used in any desirable fashion to connect consumers with individuals having a desired level of expertise in a desired area of expertise. According to embodiments of the invention, manufacturers of products in an area of expertise are notified of the individual's score and/or hierarchy of the individual's influence, and the system provides a communications platform for communications by the manufacturer to the individual.

A large variety of individuals and entities may utilize the information provided by the system to identify and evaluate experts in an area of expertise. For example, product manufacturers could use the information to identify experts in certain topics and in certain geographic areas and could determine a measure of the individuals' influence. The manufacturers could then use this information in a variety of ways. For example, with consent of the individual, the manufacturer could direct potential customers with questions to the individuals. The manufacturers could offer new products to the individuals in exchange for honest reviews. The manufacturers could offer to hire one or more of the individuals to act in a variety of capacities relating to the individuals' expertise and influence. The potential list of applications is extensive if not endless.

Other entities or individuals who could use the information maintained by the system include retailers, education or learning providers or platforms, vocational training groups and platforms, industry and/or category organizations and associations, marketing agencies, software companies such as point of sale or learning management system software providers, search engines, review sites or aggregators, content aggregators, audience aggregators, recruiting sites, competitive or athletic organizations, industry or category certifying organizations, locator sites, consumer rewards providers, mobile workforce providers, commerce platforms, social networks, and the like. While the description herein focuses on specific examples which are recited with respect to one type or example of user of the information maintained by the system, the specific examples are illustrative only, and it will be a matter of simple implementation to modify the specific example relative to the needs of a different user of the information maintained by the system, and such modifications are embraced by the various embodiments of the invention, whether explicitly or implicitly disclosed herein. Thus, embodiments of the invention provide systems and methods for quantifying, scoring, and/or ranking an individual's helpful expertise in any of a variety of areas of expertise and for any purpose, including for purposes of revealing which individuals are best qualified to give consumers helpful advice about what to buy.

In the description and claims, certain terms may at times be used interchangeably. Unless otherwise indicated by context, terms should be given their broadest reasonable scope. For example, the examples discussed herein are at times discussed using terms or phrases such as “brand” and/or “manufacturer.” Such terms may be used interchangeably and should also be understood to encompass additional terms such as retailers, advertisers, membership organizations (e.g. the National Rifle Association, the National Ski Patrol, etc.), and the like. Thus, although certain examples may be given using the terms “brand” and/or “manufacturer,” it will be understood that other embodiments and examples may be directed and/or modified to other entities, individuals, and organizations, as appropriate.

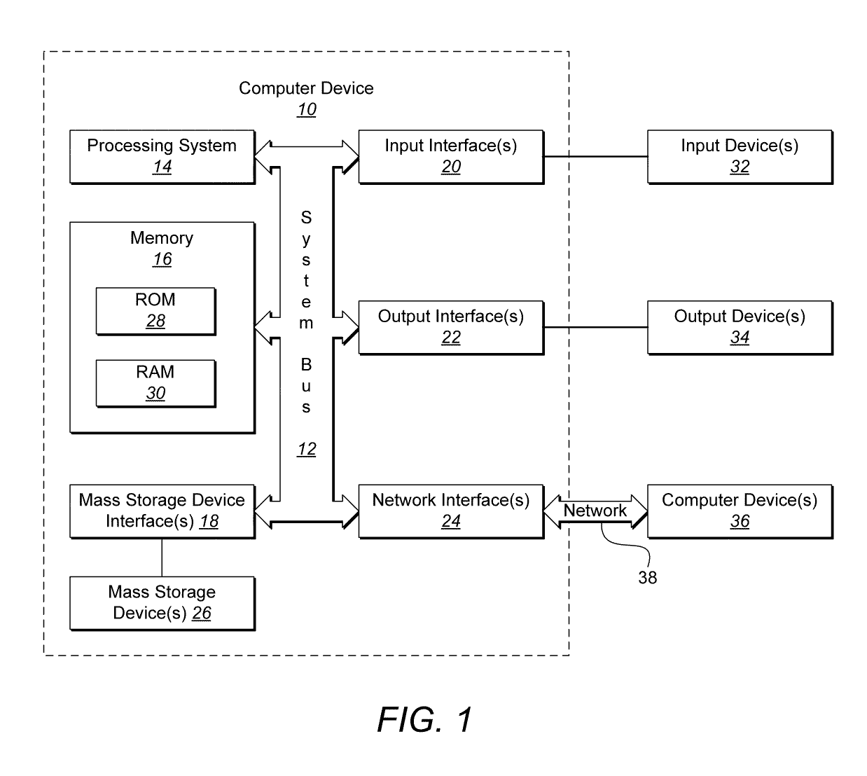

As embodiments of the invention are provided in conjunction with computer systems and networked computer systems, FIGS. 1-3 are intended to illustrate exemplary operating environments for use with embodiments of the invention. FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook or laptop computer, a netbook, a personal digital assistant (“PDA”) or other hand-held device, a smart phone, a tablet computer, a workstation, a minicomputer, a mainframe, a supercomputer, a multi-processor system, a network computer, a processor-based consumer electronic device, a computer device integrated into another device or vehicle, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

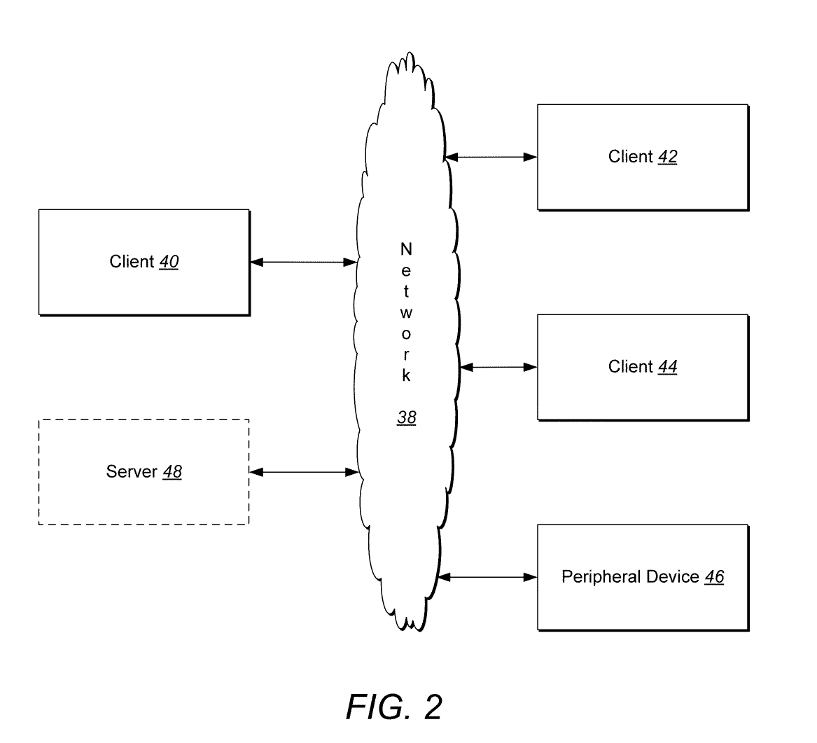

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices 46 across network 38. While FIG. 2 illustrates an embodiment that includes a client 40, two additional clients, client 42 and client 44, one peripheral device 46, and optionally a server 48, connected to network 38, alternative embodiments include more or fewer clients, more than one peripheral device 46, no peripheral devices 46, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Similarly, embodiments of the invention embrace cloud-based architectures where one or more computer functions are performed by remote computer systems and devices at the request of a local computer device. Thus, returning to FIG. 2, the client 40 may be a computer device having a limited set of hardware and/or software resources. Because the client 40 is connected to the network 38, it may be able to access hardware and/or software resources provided across the network 38 by other computer devices and resources, such as client 42, client 44, server 48, or any other resources. The client 40 may access these resources through an access program, such as a web browser, and the results of any computer functions or resources may be delivered through the access program to the user of the client 40. In such configurations, the client 40 may be any type of computer device or electronic device discussed above or known to the world of cloud computing, including traditional desktop and laptop computers, smart phones and other smart devices, tablet computers, or any other device able to provide access to remote computing resources through an access program such as a browser.

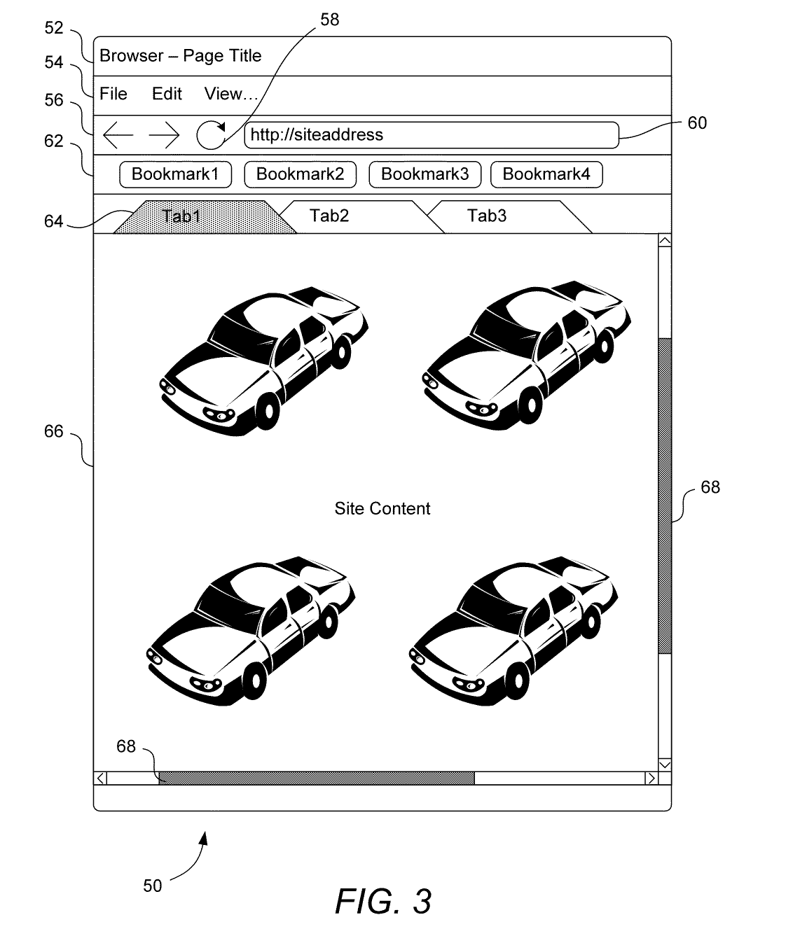

To minimize the need to download and/or install programs on users' computers, embodiments of the invention utilize existing web browser technology. Many browser programs currently exist or are under development, and it would be impossible to name all such browser programs, but examples of such programs include Microsoft's Internet Explorer, Mozilla Firefox, Google Chrome, Apple Safari, Opera Software's Opera browser, as well as myriad browsers specifically configured for specific devices, such as Internet-connected smart phones and the like. While the exact display of each browser can vary from browser to browser and while most are moderately to highly configurable so as to vary the exact display, FIG. 3 shows a representative browser window 50 similar to what might be displayed on a user's computer device. It will be appreciated that many of the features described below with respect to the illustrated browser window 50 are optional or are optionally displayed or hidden as desired by the user, but each feature is typical or illustrative of features common to many browser programs.

The browser window 50 of FIG. 3 includes a title bar 52. The title bar 52 often is used to display a page name of whatever page is actively being viewed. Most commonly, the page name that is displayed is selected by the administrator of the website being viewed, and the page name often includes one or more phrases associated with the administrator of the website and/or the page being viewed. The browser window 50 also includes a menu bar 54 that includes items that may be selected to provide access to various menu functions, as is well known in the art. Of course, the menu functions provided in the menu bar 54 may vary according to the specific browser program, among other considerations, and access to menu functions may be provide other than by a menu bar similar to menu bar 54.

The browser window 50 of FIG. 3 also includes an address bar 56, which in the browser window 50 shown in FIG. 3 includes several browser controls 58 and an address entry area 60. The browser controls 58 and the address entry area 60 facilitate browsing using the window, permitting the user, for example, to go back one or more pages, to go forward one or more pages, to refresh a page, and/or to type in a destination site's address to directly access a page. Such browser features are well known in the art and need not be further discussed.

The browser window 50 also includes a bookmark bar 62 that a user can populate with bookmarks to commonly-accessed web pages, such that the user can quickly re-access the page(s) by clicking on the relevant bookmark button. In most common browser programs, it is possible for the user to have several different websites open simultaneously, and for the browser to provide rapid access, switching between, and management of the various open sites by way of various tabs 64, as shown in FIG. 3. Each tab 64 provides access to one open website. The tabs 64 facilitate navigation between different open websites. The contents of each open and actively-viewed website may be displayed in a content area 66. Thus, the content displayed in the content area 66 may vary depending on which tab 64 is selected, and which website is being viewed.

Whereas the tabs facilitate navigating between different websites, the browser window 50 optionally includes features to facilitate navigating within a website, as is known in the art. Specifically, the browser window may optionally include one or more scroll bars 68. When a portion of the website being viewed lies outside of the viewable portion of the content area 66, the user may use the scroll bars 68 to access non-visible portions, as is known in the art.

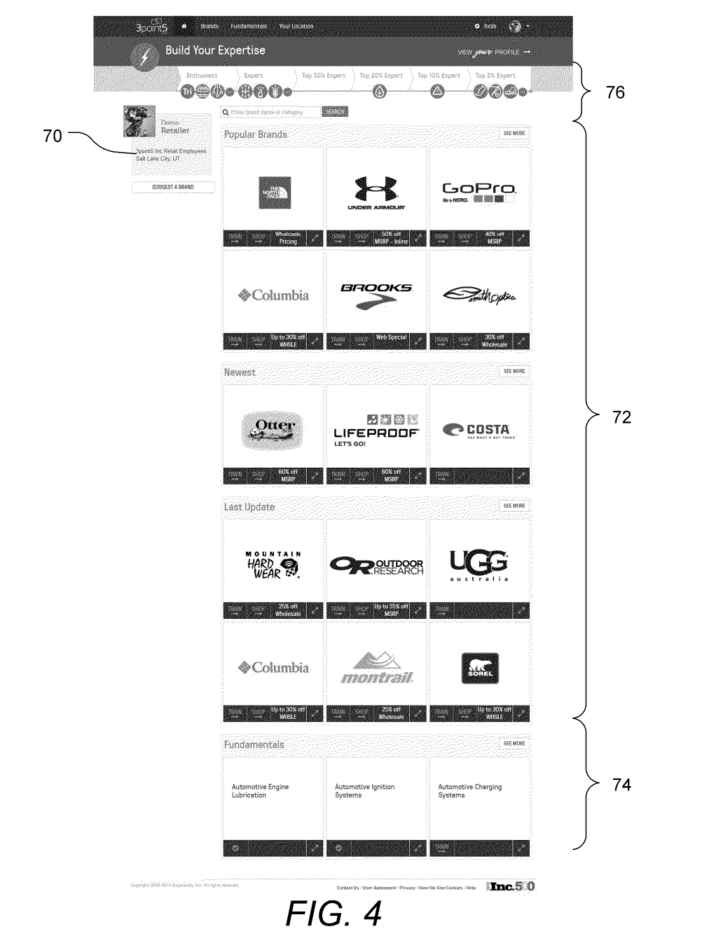

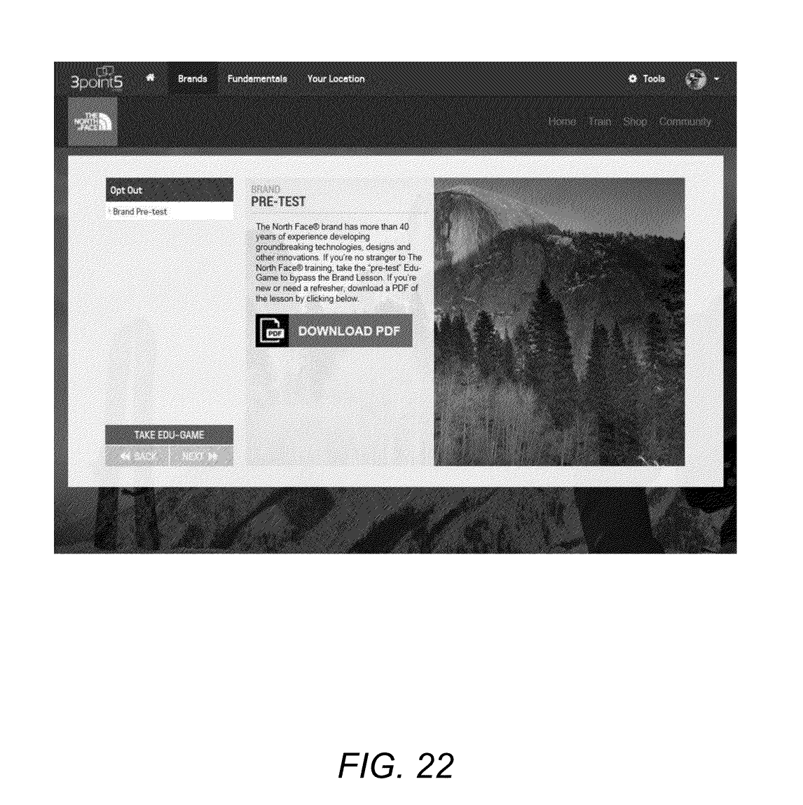

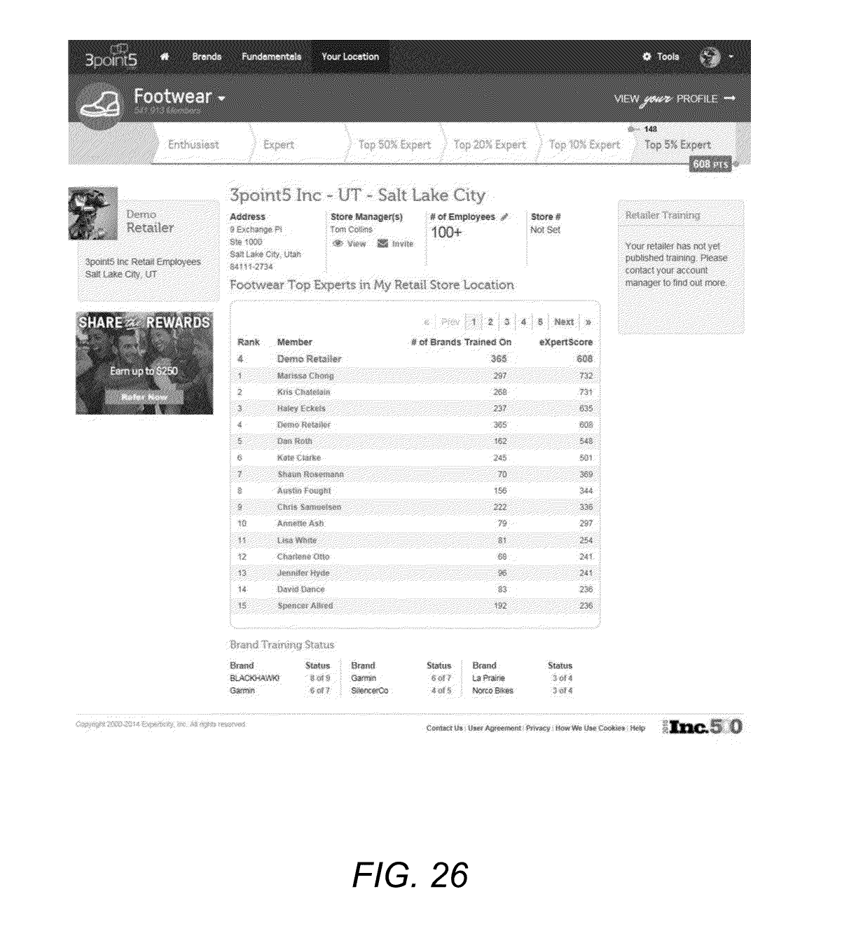

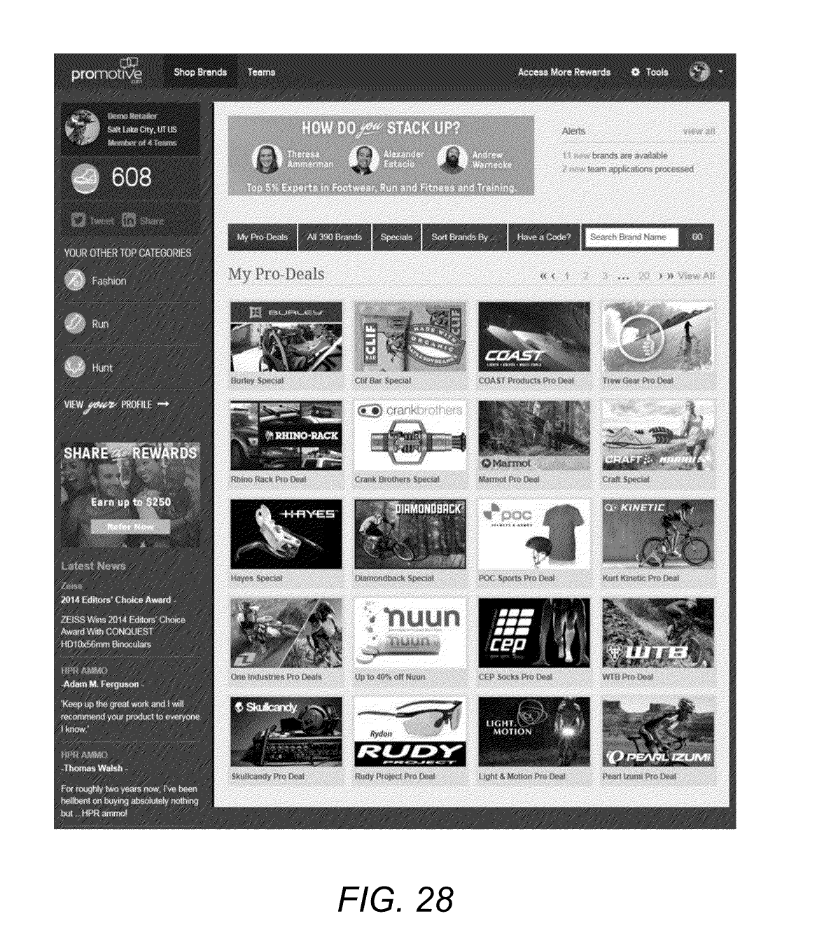

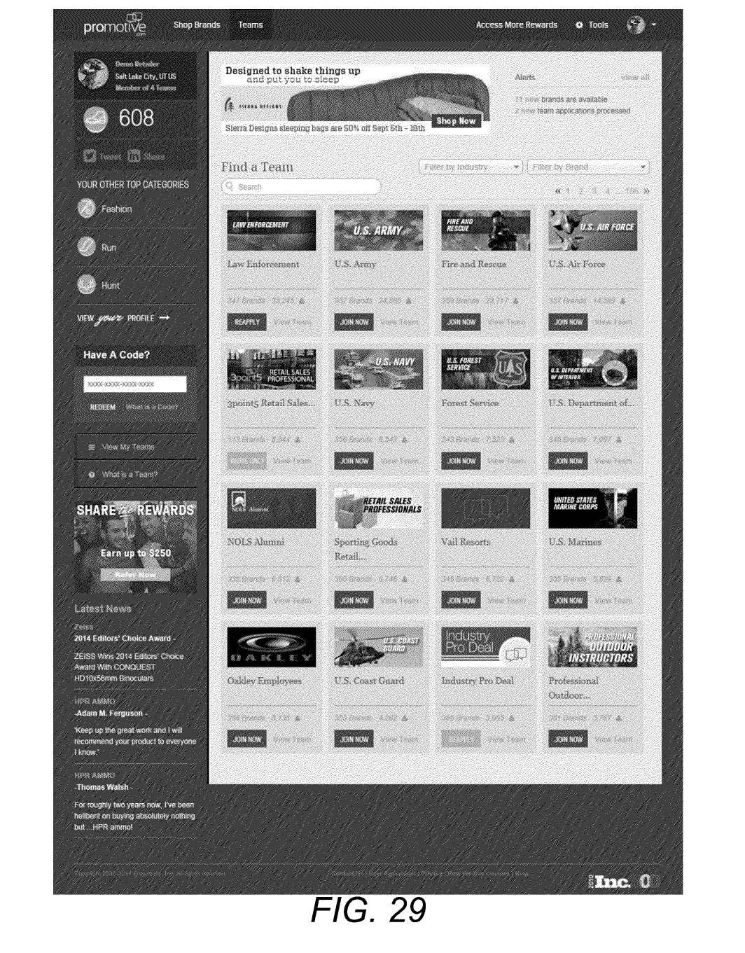

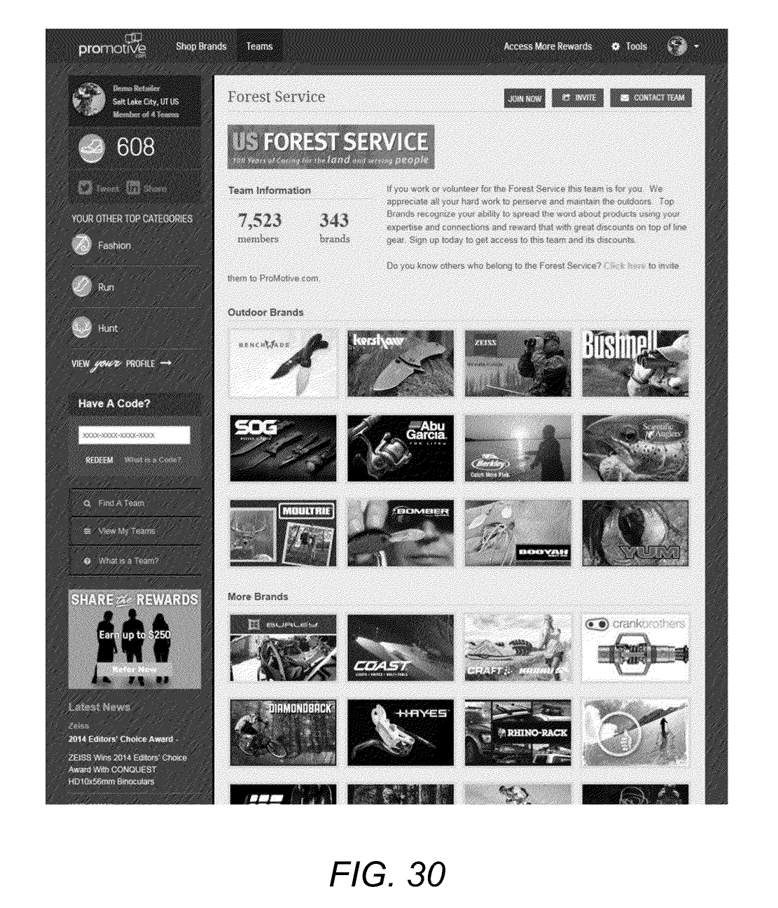

FIGS. 4-30 show illustrative screen shots of web pages illustrating features of embodiments of the invention discussed above. In FIGS. 4-30, the screen shots are limited to information displayed in the content area 66 or capable of being displayed in the content area 66, or portions thereof—at times portions of the representative web pages that might lie outside of the viewable portion of the content area are omitted for purposes of clarity in discussing embodiments of the invention.

It should be understood that while embodiments of the invention are illustrated as being provided through a web browser interface, they may be provided by any other desired interface. By way of example and not limitation, features similar to those discussed herein may be provided using a standalone desktop application on a desktop, laptop, or tablet computer, or the like. Similarly, features similar to those discussed herein may be provided using an app installed on a mobile device such as a smart phone, tablet computer, or the like. Features similar to those discussed herein may similarly be provided by a dedicated device that has been dedicated to providing features in accordance with embodiments of the invention. Therefore, the discussion herein is not intended to limit embodiments of the invention to the specifically illustrated embodiments or to the features discussed or illustrated thereby.

FIG. 4 shows a representative webpage in accordance with embodiments of the invention, shortly after an individual has logged in to the system. A user-information area 70 shows some basic information about the individual who has logged in. A brands area 72 shows a variety of brands/manufacturers with which the individual can interact. The individual can interact with the brands by purchasing products of the brands and by participating in training modules provided by the brands. The individual may also be able to view news or other information provided by the brands, as is discussed in more detail below. As shown in FIG. 4, brands may be divided or categorized according to any of a variety of categories, such as popularity, newness, most recent update, and the like. The individual may elect to view more brands in a certain category (e.g. more “popular” brands) by selecting an appropriate link (e.g. “see more”) from within the web content.

A training fundamentals area 74 shows training modules available to the individual that are not affiliated with any particular brand. In the training fundamentals area 74, the system may display training modules, but will not provide options relating to purchasing products from any particular brand. As with the items in the brands area 72, the items in the training fundamentals area 74 may be categorized into any of a variety of categories. Additionally, as with items in the brands area 72, the items in the training fundamentals area 74 may be only a subset of available items, and the individual may elect to view more training fundamentals items by selecting an appropriate link from within the web content.

Near the top of the page, an expertise area 76 graphically represents to the individual the levels of expertise that the individual has attained in various categories or areas of expertise. The graphical representation shown in FIG. 4 is only illustrative and may be varied as desired. The expertise area 76 is divided horizontally into varying levels of comparative expertise (compared to other users of the system). In this example, the expertise area 76 is divided into the following categories: Enthusiast, Expert, Top 50% Expert, Top 20% Expert, Top 10% Expert, and Top 5% Expert. These areas are intended to represent to the individual (as well as to anyone else seeking information about experts in an area of expertise) the individual's expertise relative to other users of the system.

The Enthusiast category may be intended for individuals who have expressed interest in an area, but have not yet demonstrated a basic level of competence in that area, whether through knowledge, experience, product ownership, third-party reviews or other indicia of helpfulness, or otherwise. The system may have established a base level of competence for qualifying individuals to move up in an area to the Expert category, and the difference between the Enthusiast category and the Expert category may be set at a fixed level, or it may be comparative to other users of the system. Where the difference is set at a fixed level, the individual may progress from Enthusiast to Expert in an area of expertise by accumulating a fixed base level influence score through any combination of knowledge, experience, product ownership, third-party reviews or other indicia of helpfulness, or any other evaluative factor discussed herein. If, however, the transition between Enthusiast to Expert is comparative to other users of the system, a certain percentage of users with the lowest influence scores will belong to the Enthusiast category.

In contrast, the distinction between the various levels of other categories (e.g., Expert vs. Top 50% Expert) are all intended to be comparative to other users of the system. Thus, only those users who have influence scores in the top 5% of influence scores (and possibly ties) in an area of expertise will be qualified for the Top 5% Expert category in that area of expertise. Similarly, only those users who have influence scores in an area of expertise in the top 10% of influence scores (and possibly ties) but who do not qualify for the Top 5% Expert category will be members of the Top 10% Expert category in that area of expertise.

This division of expertise is intended to incentivize and motivate all individuals who use the system to take action to improve their expertise scores in their areas of interest. Many individuals whose level of knowledge, experience, product ownership, third-party reviews or other indicia of helpfulness, or other evaluative factor only qualifies them as a Top 50% Expert will be motivated to take whatever actions are available to them to improve their scores to reach the Top 20% Expert category in that area of expertise. Once an individual has achieved a desired level of comparative expertise, he or she will remain motivated to take action as necessary to maintain that level of comparative expertise, but will likely have to continue to take action to do so as other users will be taking action to increase their own knowledge, experience, product ownership, and the like. Thus, most users of the system will remain motivated to participate in the system and maintain or improve their influence scores in various areas of expertise, those of interest to them.

Within the expertise area 76, the individual's various levels of expertise in different areas of expertise are represented by graphics in circles, the graphics intending to represent each area of expertise in some way. Where a circle falls within the Top 5% Expert area, that represents that the individual's influence score in that area of expertise qualifies for the Top 5% Expert designation. Where the individual's scores qualify him or her for more Top 5% Expert designations than can be shown in the current display, some sort of indicator may be present to show that other areas are also qualified and available for viewing by the individual.

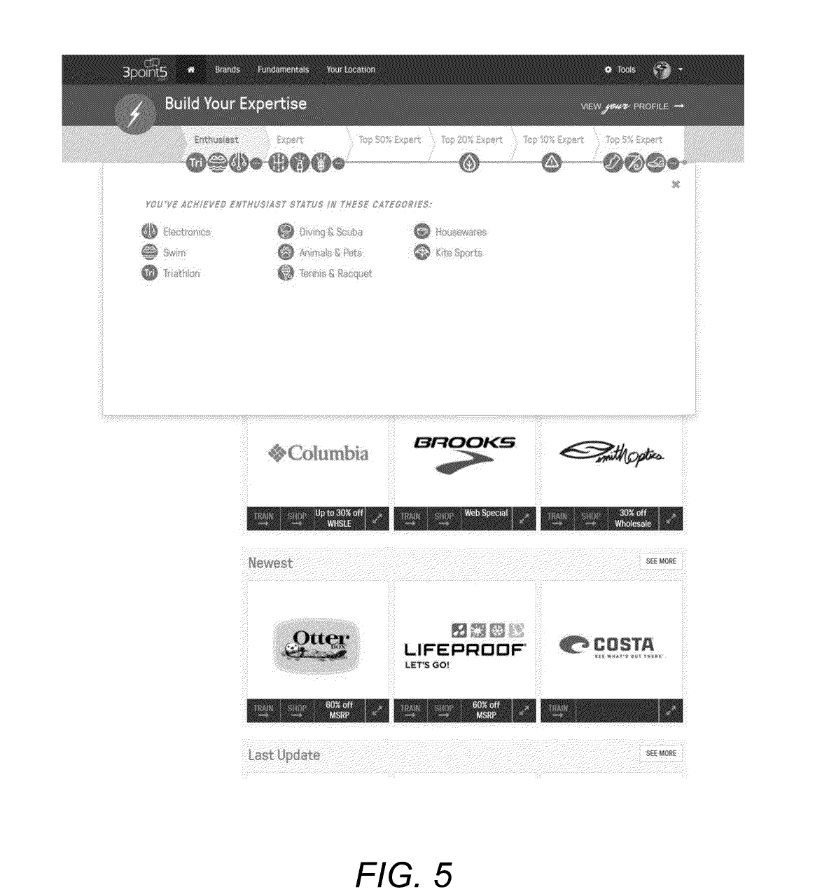

In the illustrated example of FIG. 4, for instance, if the individual were to click on the Enthusiast category, the display might change to that shown in FIG. 5. In this Figure, the Enthusiast category has been expanded to show all areas of interest available in the system that the individual has an influence score assigning him or her to the Enthusiast category. In the display of FIG. 5, the areas of interest are represented both graphically (as circle graphics) as well as textually. Any desired method may be used to display information to the user. In this specific instance, the individual has an Enthusiast influence score in the areas of electronics, swim, triathlon, diving and scuba, animals and pets, tennis and racquet, housewares, and kite sports.

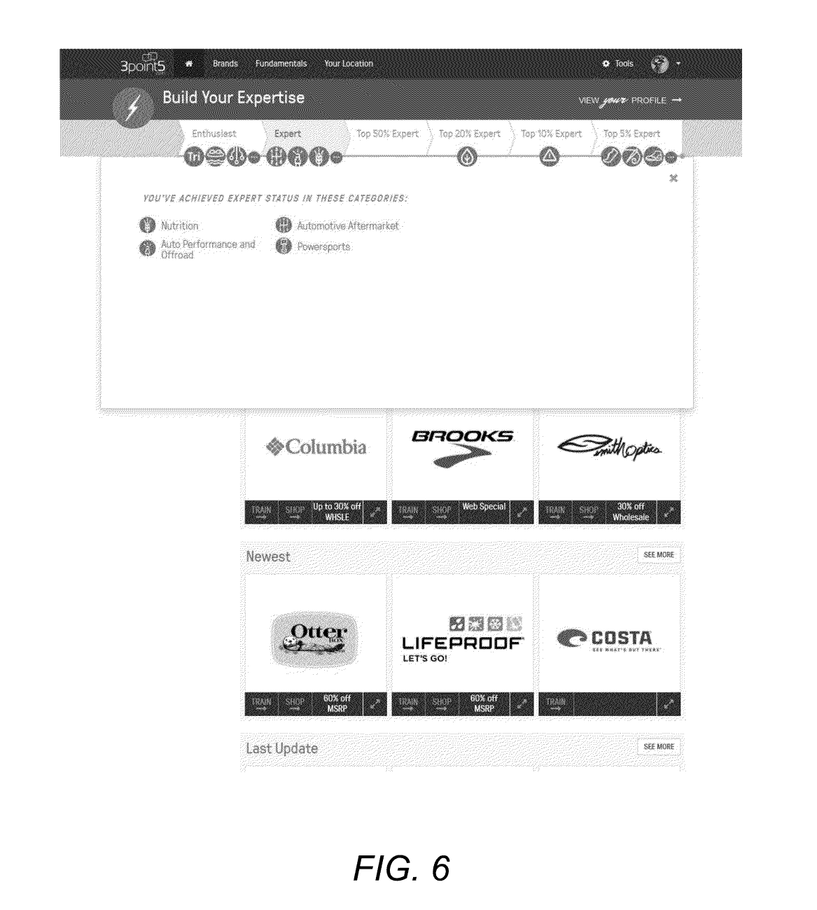

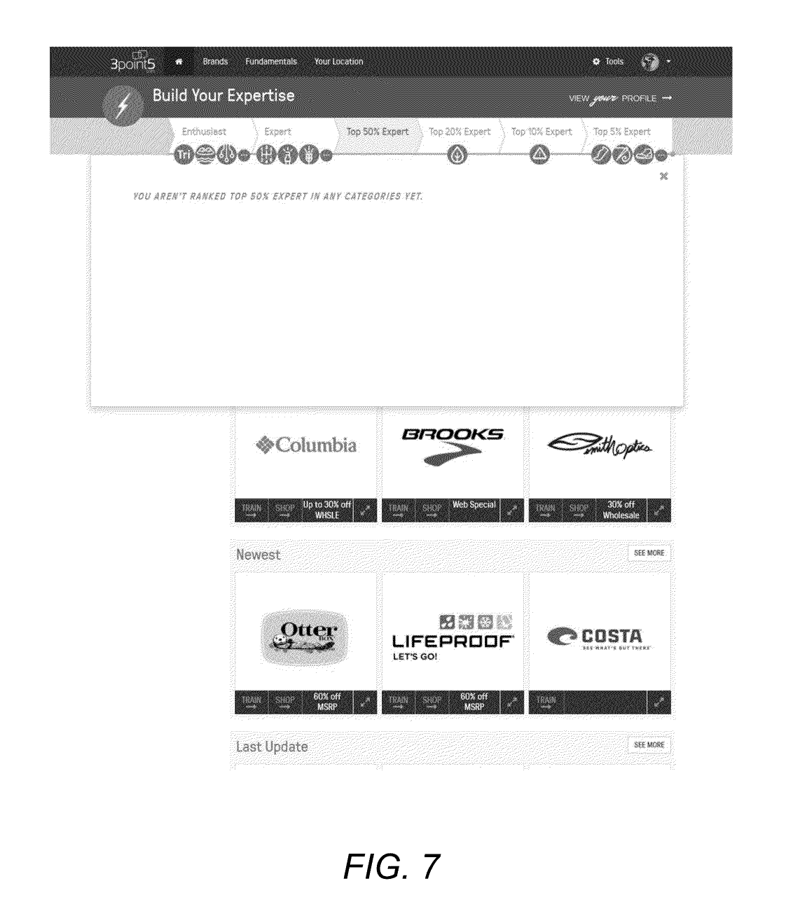

If the individual were to click on the Expert category, the view might change to that of FIG. 6. The display is similar, except the qualifying areas of interest have changed. In this specific instance, the individual has an Expert influence score in the areas of nutrition, auto performance and offroad, automotive aftermarket, and powersports. If the individual were then to click on the Top 50% Expert category, the view might change to that of FIG. 7. The display is again similar, except for the changing qualifying areas of interest: in this case the individual does not have an influence score in any area of expertise that satisfies the Top 50% Expert criteria.

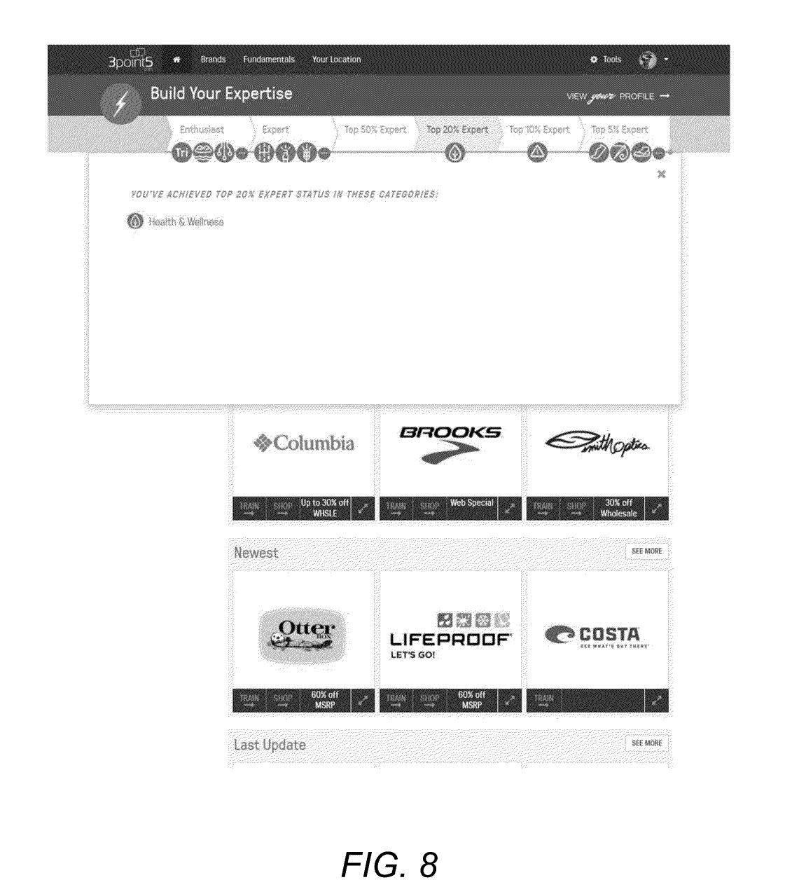

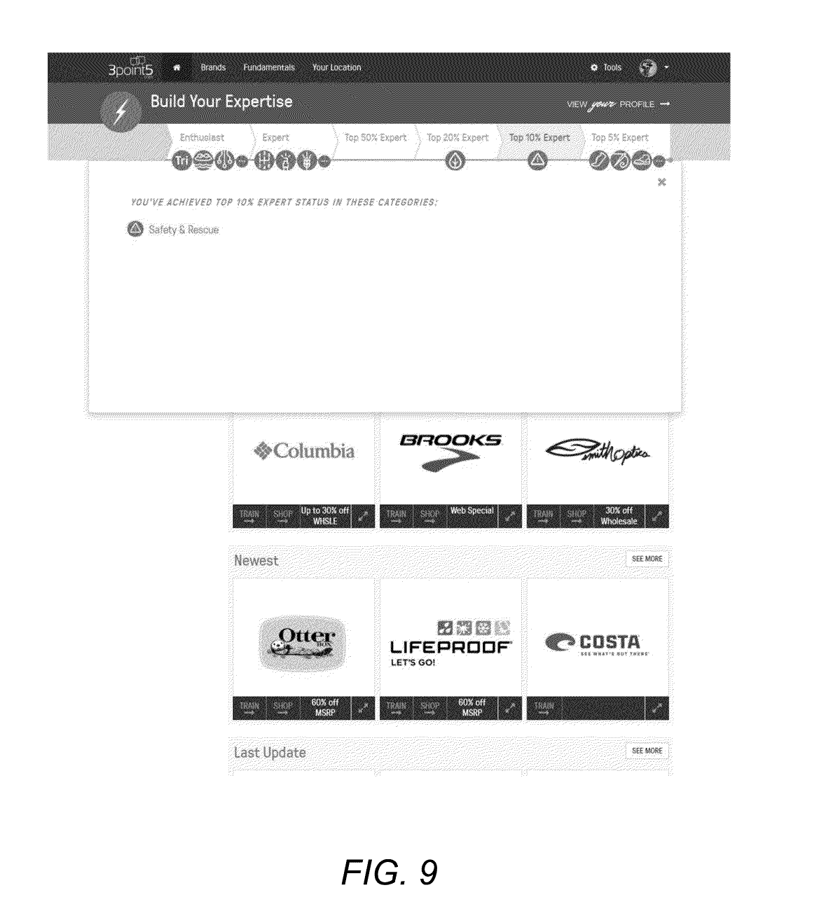

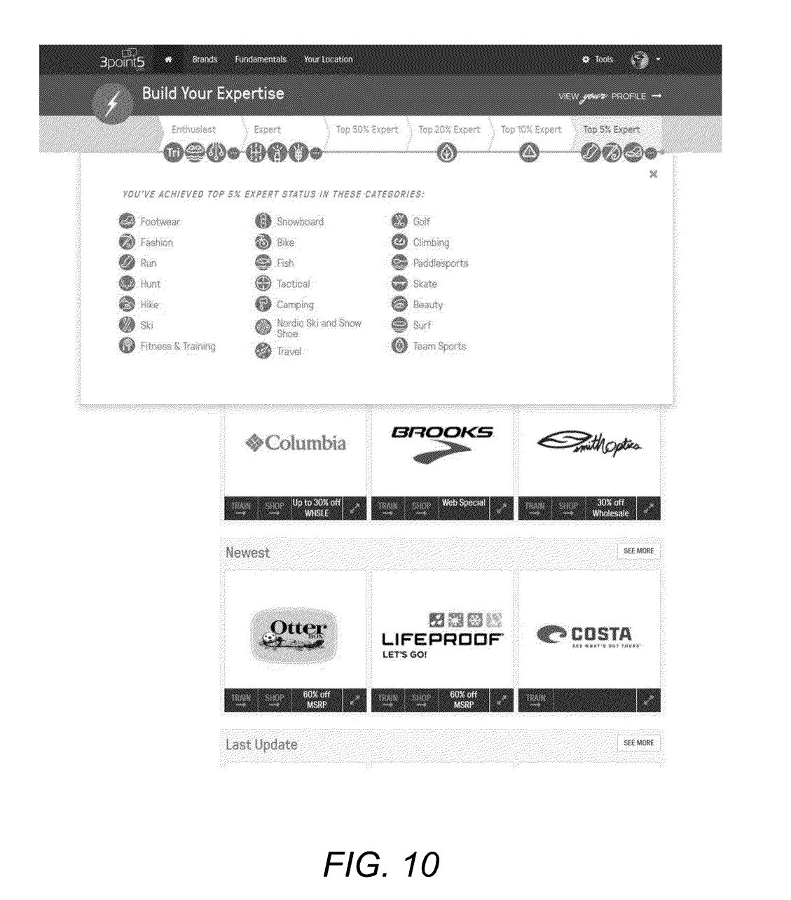

If the individual were to click on the Top 20% Expert category, the view might change to that of FIG. 8, which again has a similar display but with different qualifying areas of expertise: health and wellness only. If the individual were to click on the Top 10% Expert category, the view might change to that of FIG. 9, and display the individual's areas in which his or her influence score qualifies for the Top 10% Expert category, namely safety and rescue. Finally, if the individual were to click on the Top 5% Expert category, the view might change to that of FIG. 10, displaying the categories of footwear, fashion, run, hunt, hike, ski, fitness and training, snowboard, bike, fish, tactical, camping, Nordic ski and snowshoe, travel, golf, climbing, paddlesports, skate, beauty, surf, and team sports. Of course, the categories described with reference to FIGS. 5-10 are only intended to be illustrative: other or additional categories might be used.

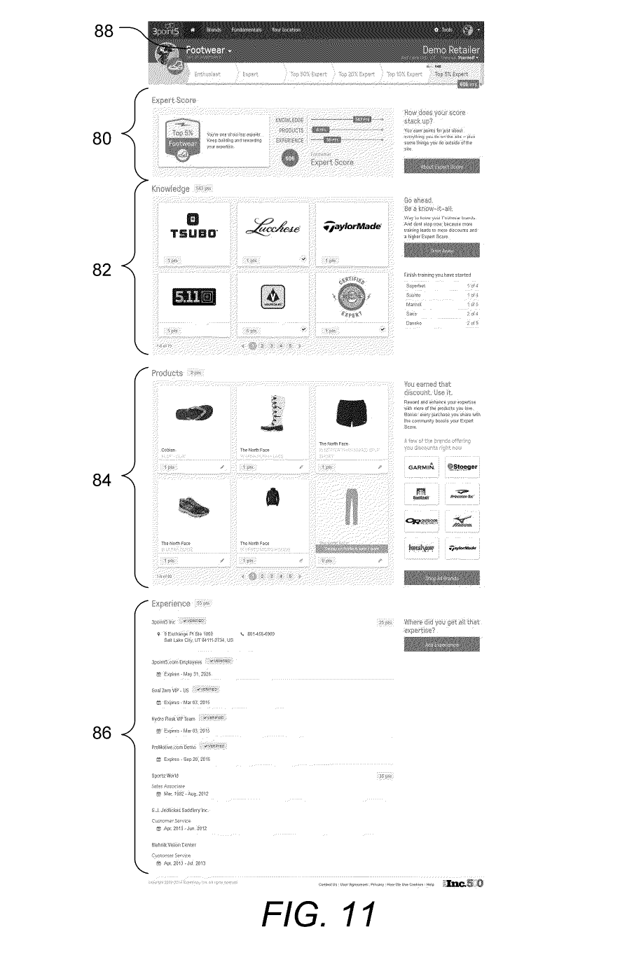

If the user were to click on or otherwise select one of the categories shown in the displays of FIGS. 4-10, “Footwear” for example, the view might change to something similar to that of FIG. 11. In FIG. 11, the left approximately three quarters of the page is divided into vertical sections. The uppermost section 80 shows the individual his or her comparative expert influence score (Top 5% Expert in this case), as well as several sliding graphs indicating the components of the score that make up his or her score in that area. The second section 82 is a knowledge section displaying brands offering training relevant to the area of expertise. As before, additional brands may be displayed by selecting one or more webpage elements indicating a desire to view additional items. In this example, each brand tile is annotated with a points value so the individual can see how many points from his influence score are attributable to knowledge gained through training modules offered by each brand. The user may elect to improve his or her influence score through additional training, as will be discussed in more detail below.

The third section 84 is a products section displaying products owned by the individual, as well as the points of the individual's influence score attributable to his or her ownership of or familiarity with each product. Again, additional products owned by the individual or with which the individual is familiar and recorded in the system may be viewed by selecting applicable webpage elements as discussed above. As the individual acquires or becomes familiar with additional products, his or her product component of the influence score may increase. As discussed herein, the system may require products to be purchased from within the system, or it may allow the user to input products acquired through other means. Thus, in some instances, the system may require proof of ownership of products, while in other circumstances, the system may rely on user input related to ownership of or familiarity with products. Said differently, certain embodiments of the system may require ownership of the products for their entry in the system, while other embodiments may permit the individual to enter products owned by the individual and/or products with which the individual has become familiar, even without current ownership.

The fourth section 86 is an experience section that reflects the individual's experience or achievements in the area of expertise. The information contained in the experience section may include information input by the individual. The information in the experience section may alternatively or additionally include information obtained by the system from one or more other sources, such as from social media sites or applications, from other websites or applications, from employers, from devices owned by or used by the individual, or from any other source. The information in the experience section may also include location or activity information obtained from any of a variety of devices, such as exercise and fitness tracking devices, global positioning system (GPS) or other location devices, smart phones, smart watches, and the like. For example, if the individual possesses a location device and wishes to obtain experience points within a mountaineering category of expertise, the location device may obtain or reflect information indicating that the individual spent time on or summited Mount Everest, and the system could obtain that data from the location device and assign points accordingly.

The information in the experience section may include information pertaining to any type of experience, activity, or knowledge that might not be reflected in other categories. For example, the information in the experience section might reflect past or present work experience, past or present employment, past or present affiliations, past or present memberships, past or present places of residence, brand certifications, industry certifications, manufacturer certifications, category certifications, education, any other third-party certifications, achieving a certain rank within a category in the system, achieving a certain rank within a peer group, achieving a certain rank within a work group, achieving a certain rank in a competitive event, achieving a certain rank on a third-party system with relative brand, category, and/or industry characteristics, and/or any other information that may be relevant to determining an individual's influence score.

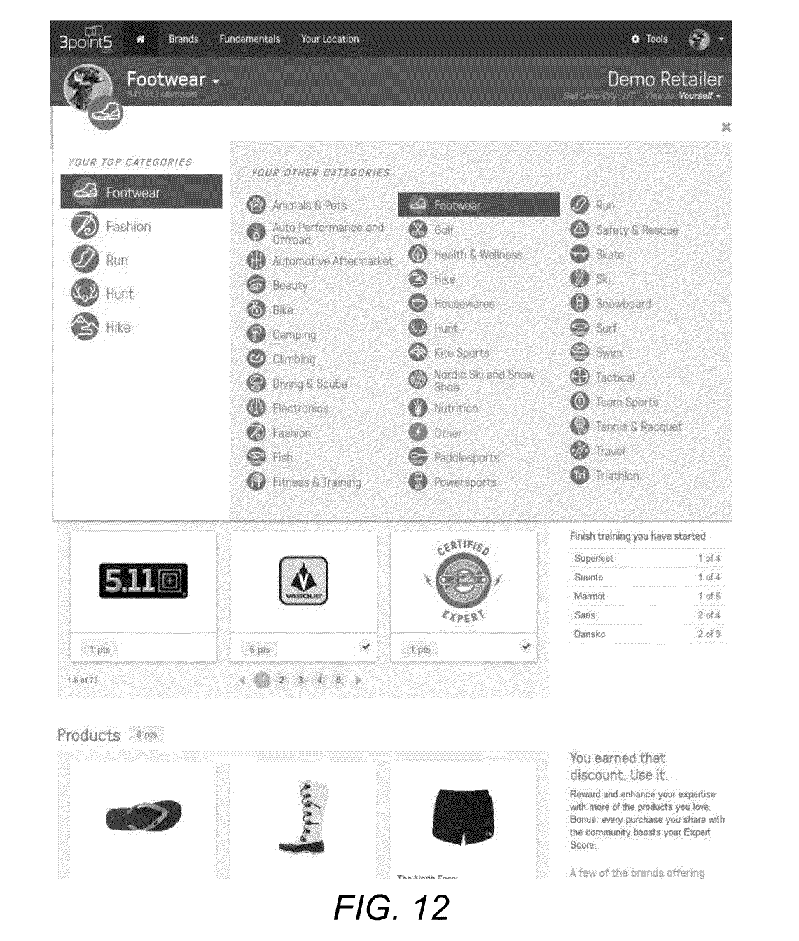

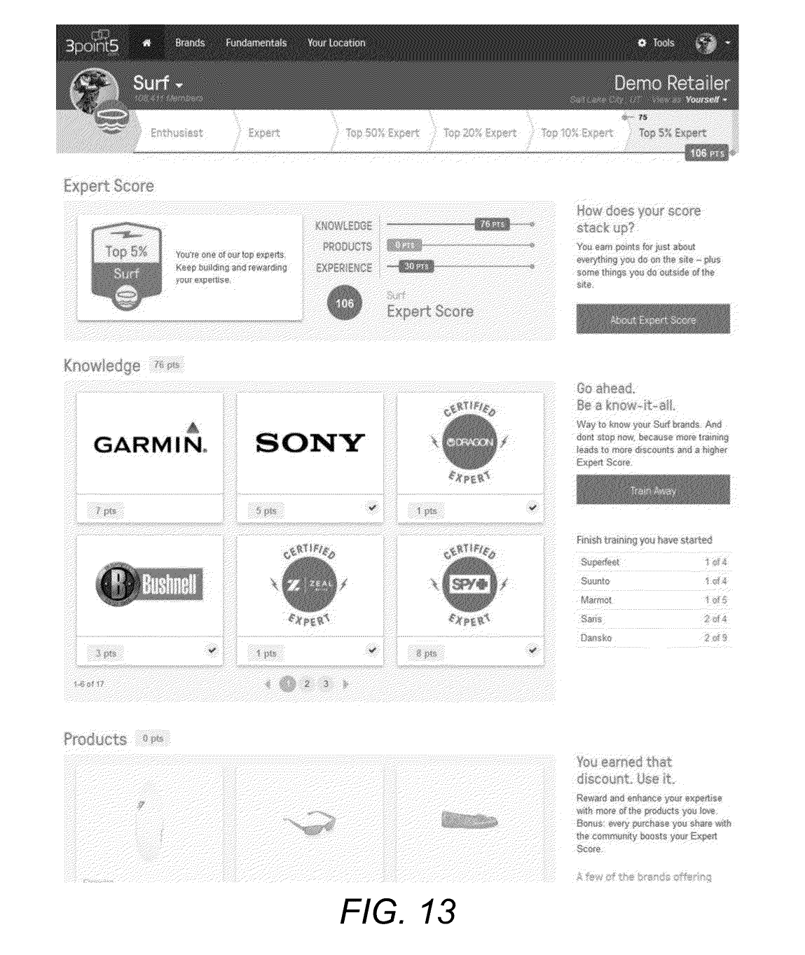

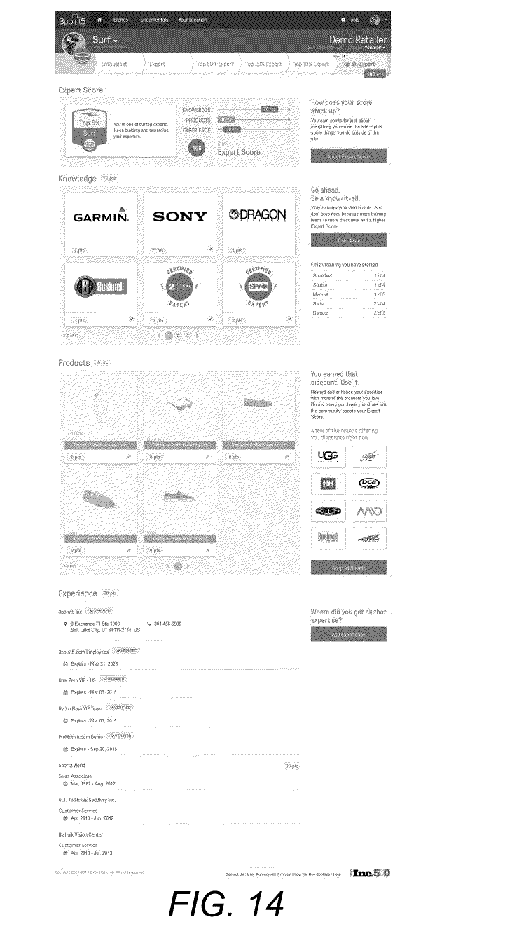

FIG. 11 also shows the current category as a pulldown link 88 near the top of the webpage. If the user were to select the pulldown link 88, the webpage display might change to something similar to that shown in FIG. 12. This display shows the individual's top categories (footwear, fashion, run, hunt, and hike), as well as the individual's other categories. If the individual were to select a category different than “footwear,” such as “surf,” the page displayed might change to something similar to FIGS. 13 and 14. In FIG. 13, only an upper portion of the page is displayed. This new page shows the individual the components of his or her influence score for this new category in similar fashion.

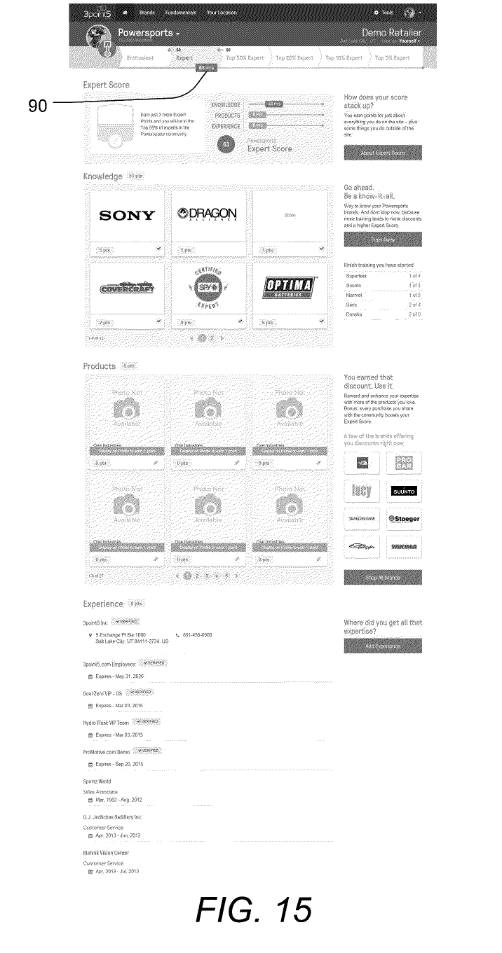

Selecting a different category, such as “powersports,” may show a different page, such as that of FIG. 15. The display is similar, except that this category is one in which the individual's influence score only qualifies him or her for the Expert category. Near the top of the page, a points slider 90 visually illustrates to the individual where his or her influence score falls to further motivate the individual to take action to increase the score.

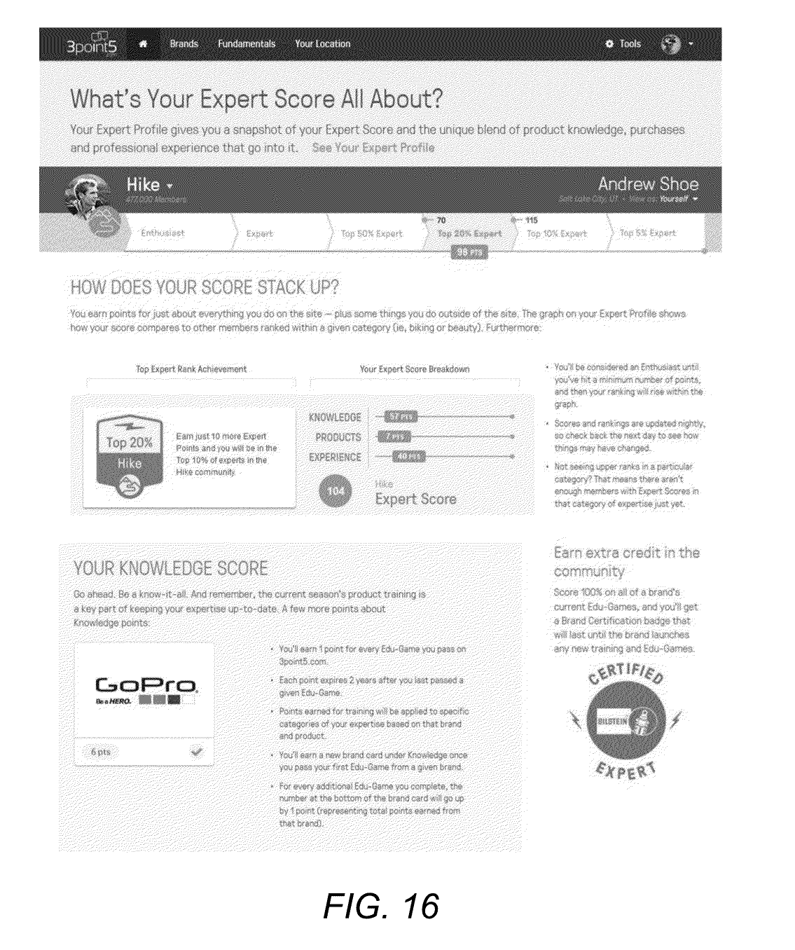

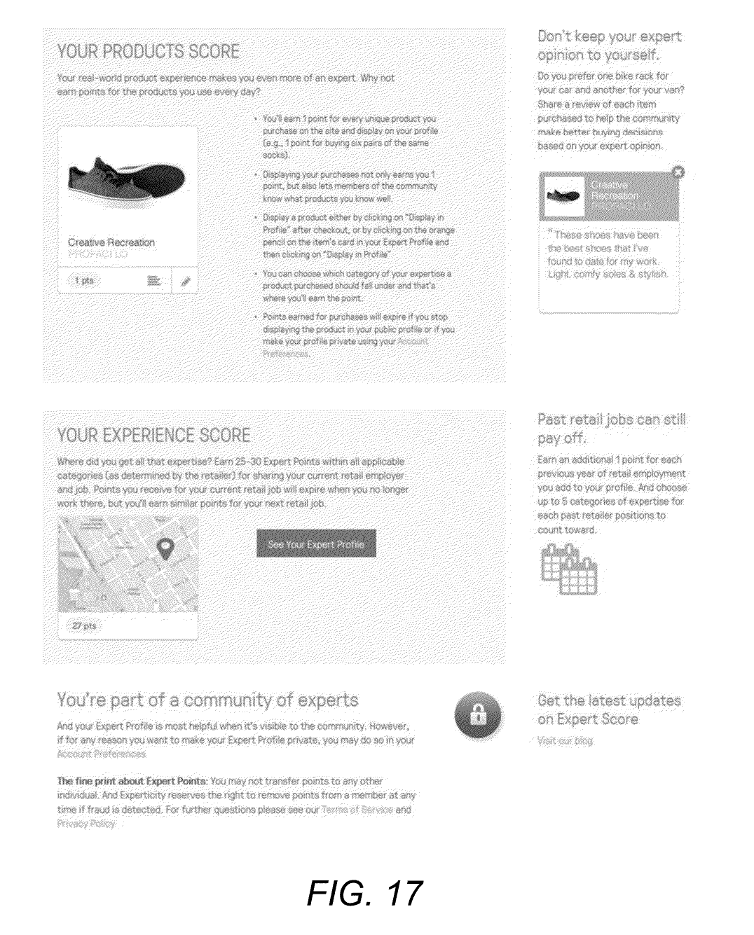

FIGS. 16 and 17 show information relating to certain ways in which the influence score may be determined and calculated. In this example, the knowledge score is computed by giving one point to the individual for every applicable knowledge quiz passed on the site. Each point expires two years after the individual last passed that knowledge quiz (the quiz may be taken again at any time). Training materials or modules are available for each quiz, typically provided by manufacturers and relating to the manufacturers' products. Points earned for training and passing quizzes are applied to categories of expertise based on the associated brand and product. Brand cards are gained once the first quiz is passed for a given brand. For each additional quiz passed for that brand, the number of points for that brand will increase.

In this example, the products score is computed by giving one point for each unique product purchased on the site and displayed on the individual's profile. In other examples, the individual is allowed to display and receives points for displaying other products owned, regardless of whether they are purchased through the site. The displaying of the products on the individual's profile lets other members of the community know the products with which the individual is familiar. In this example, the individual is able to select a single category where the product's point will be applied. The points earned for the products will expire if the product is no longer displayed or if the individual makes his or her profile private (which also removes any public display of the product).

In this example, the experience score is determined by the individual's current employer. Thus, points for a particular employment position will expire when the employment ends, but new points will become available from any new employment.

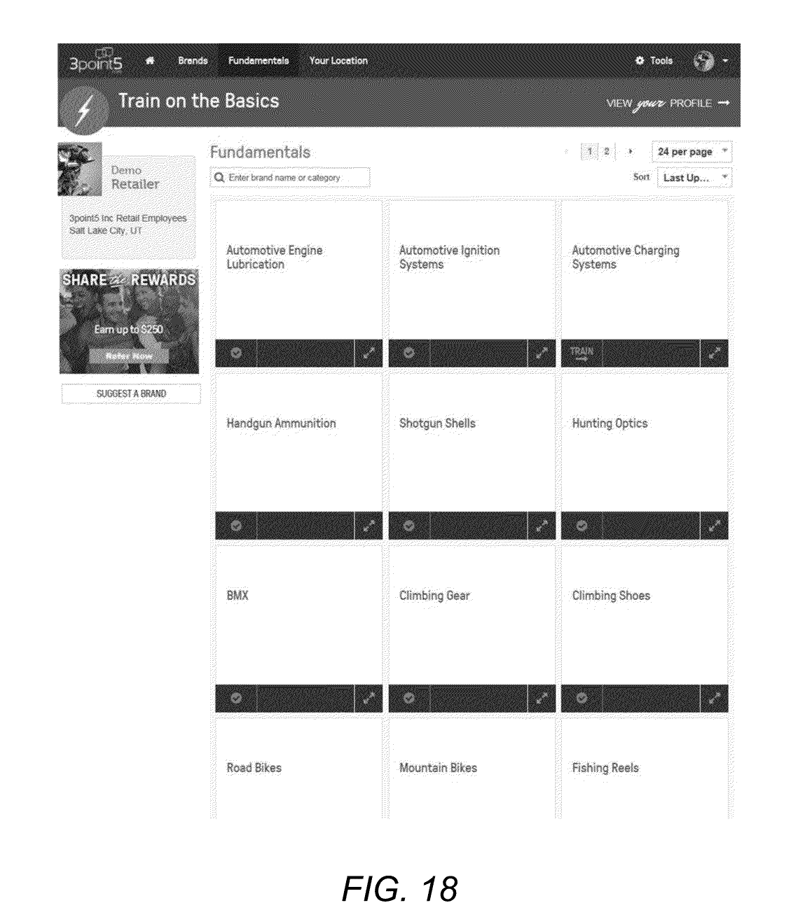

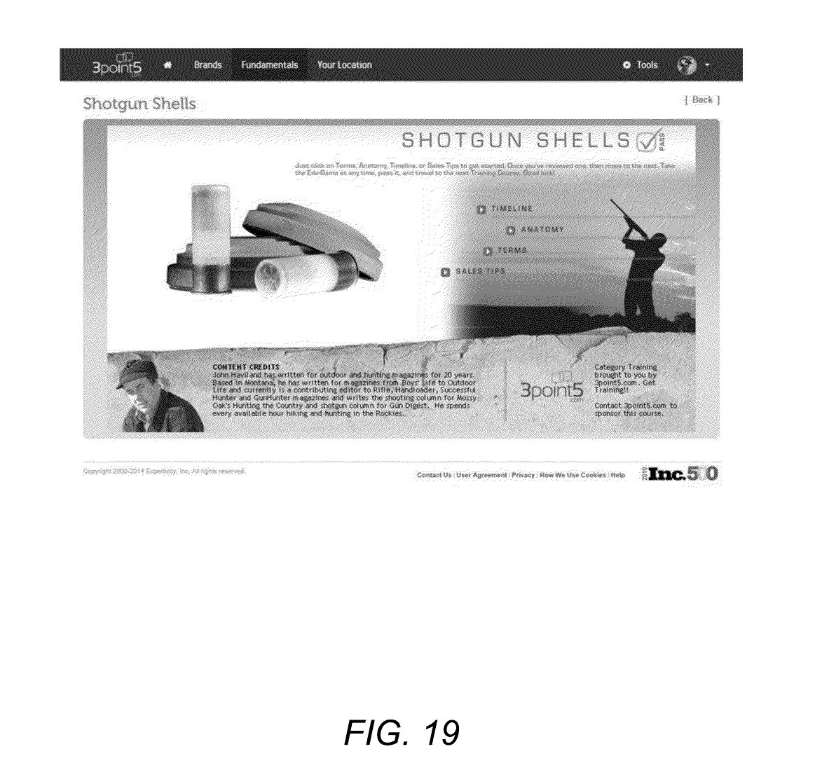

FIG. 18 shows a representative display of fundamental training categories available to the individual. Such a display might be displayed if the individual elected to expand the training fundamentals area 74 of FIG. 4. Indicators may show the individual which trainings have already been completed, and which areas remain to be reviewed. Training may be delivered online over the individual's web browser, and a quiz may be delivered at the end of training to ensure comprehension. When the user selects a training module, for example, the view might change to something similar to that shown in FIG. 19, or any other desired display that permits the delivery of information to the individual.

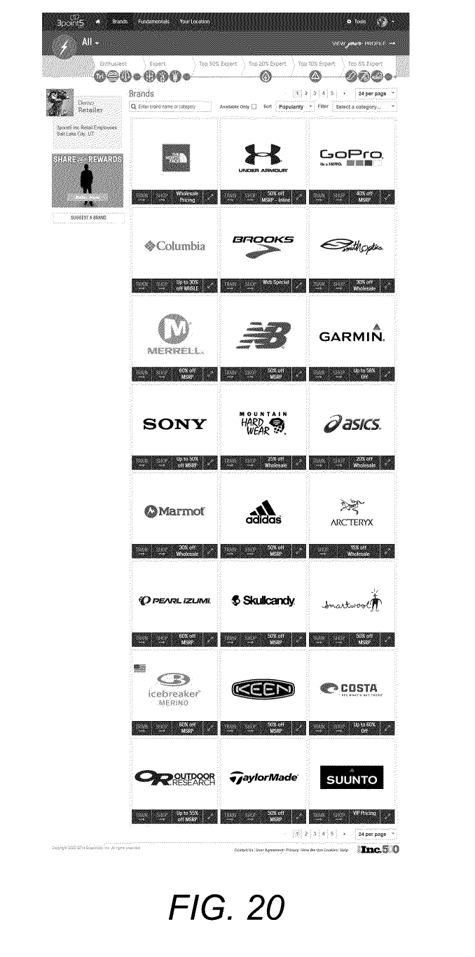

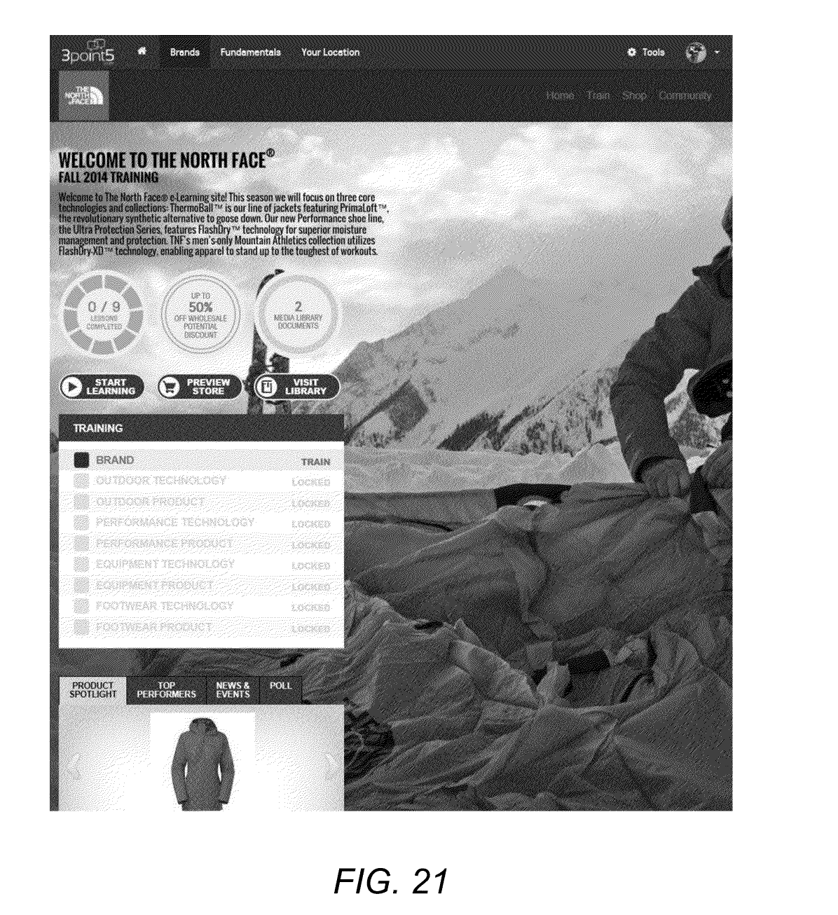

Training may also be available through links associated with the various brands and manufacturers. FIG. 20, for example shows a representative display that might be provided upon selecting a link to show various brands. Each brand tile includes a link for training as well as a link for purchasing products. If the individual selects one of the links for training, the display might change to something similar to that of FIG. 21.

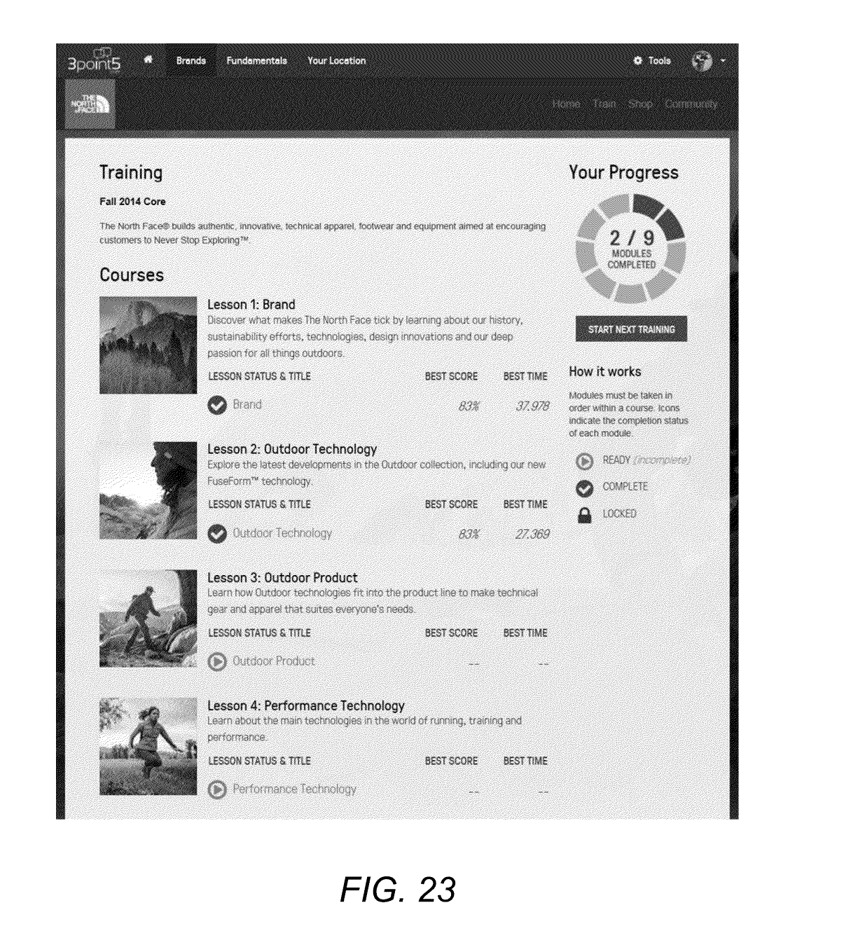

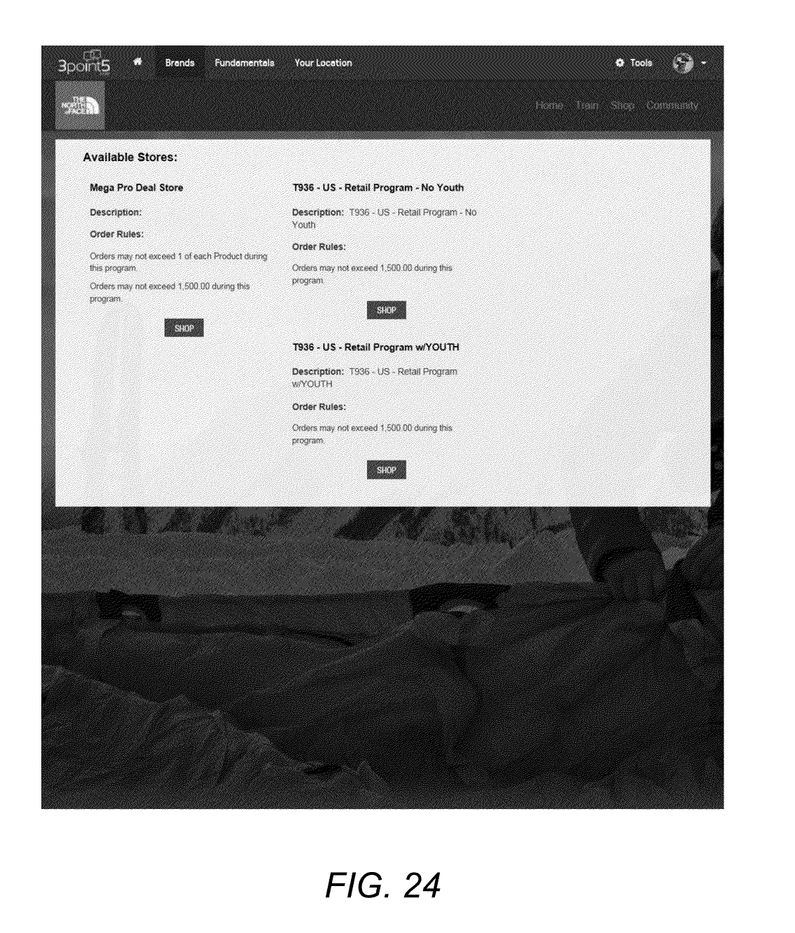

FIG. 21 shows a brand-specific training page providing information provided by the applicable brand. The training information may include multiple training modules, and the information may be applicable to products of the manufacturer/brand. The displayed web page may provide a variety of navigational tools allowing the individual to select and obtain desired training. The training is provided by the manufacturer, and the manner in which points are assigned to specific categories for completion of the training may be determined by the manufacturer as well. As the user progresses through various brand-specific training materials, pages such as those shown in FIGS. 23 and 24 may be displayed.

As discussed above, each manufacturer/brand may have a link to permit purchase of the products offered by the manufacturer. Selection of such a link may lead to a display similar to that of FIG. 24. The individual is able to enter a store affiliated with the manufacturer/brand, and is then able to purchase products, possibly at a discount provided to users of the system. As discussed above, the purchaser is then able to display any purchased products on his or her profile.

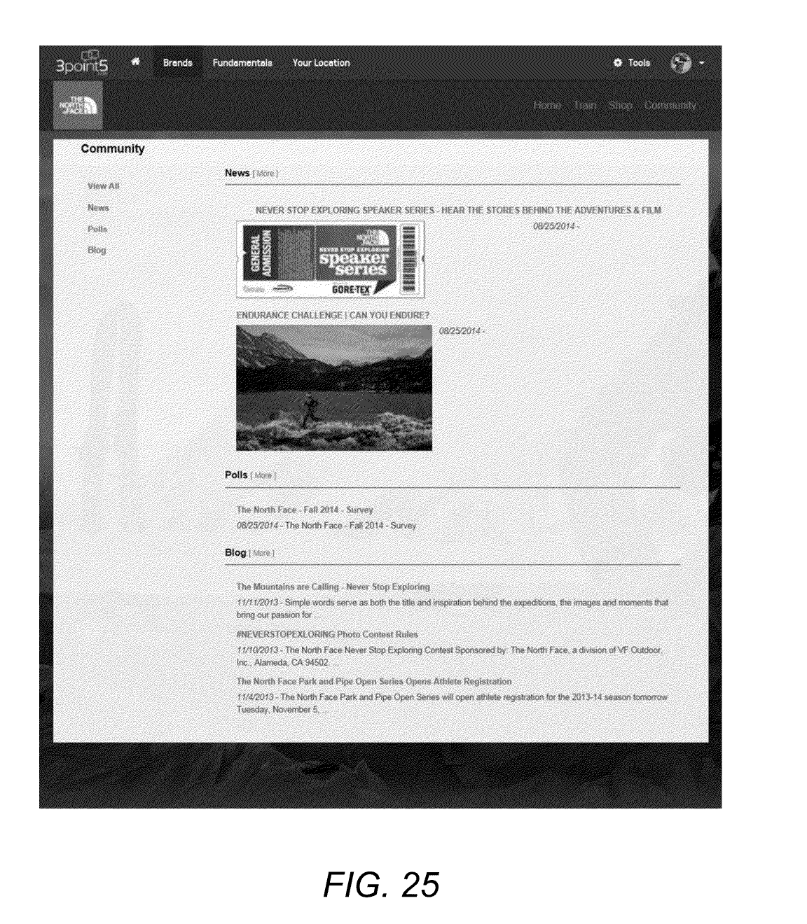

Manufacturers may also provide any number of other informational links and items. For instance, a manufacturer may provide a news link that may lead to a page similar to that of FIG. 25. The news may be any type of news, including new product news/announcements, new training announcements, blog entries, and the like.

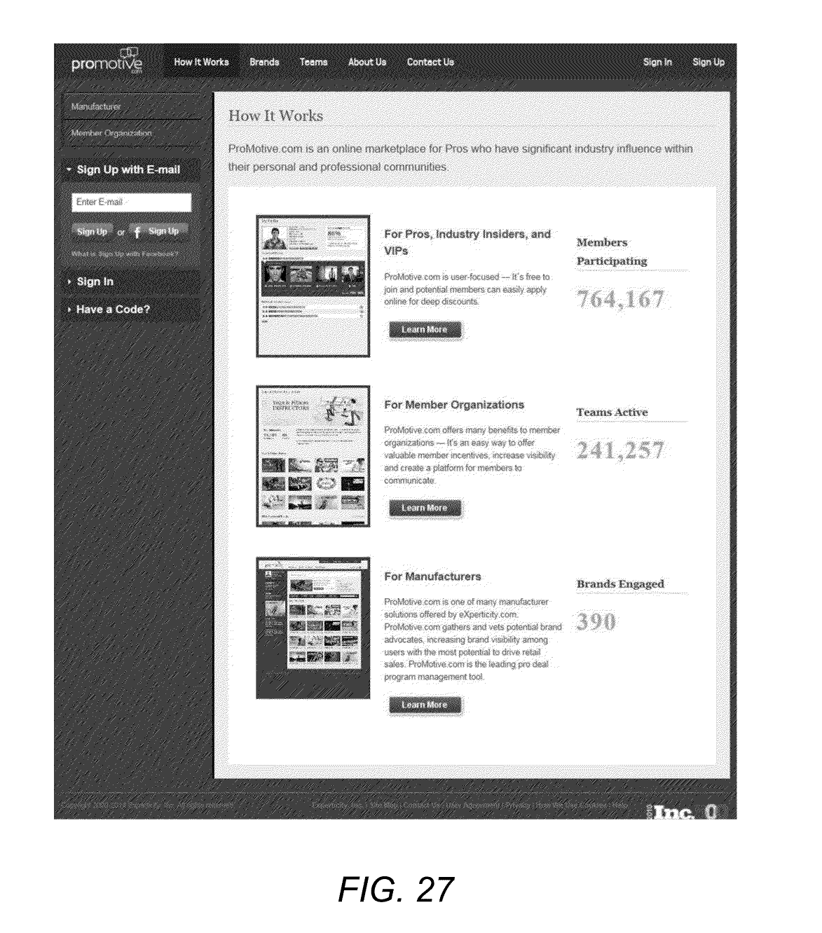

FIGS. 27-30 show screenshots taken from an alternative site that may provide features similar to those discussed previously, with some modifications. In this example, the site may be further organized according to organizations or affiliations. In this fashion, the system creates a type of social network of engaged individuals who are able to share information and otherwise communicate with each other. Individuals who participate may qualify for varying influence score-based statuses, in similar fashion to that discussed above. In addition, however, individuals are able to join one or more teams to find and form networks of individuals who are engaged with similar products and brands. Teams may become affiliated with products and/or brands, and members who join certain teams may thus become exposed to brands, manufacturers, and products they otherwise might not have become familiar with.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A non-transitory computer-readable medium storing computer-executable instructions to cause a computer system to execute a method for tracking individuals' category, industry, or brand expertise, the method comprising:
receiving and storing data evidencing an individual's knowledge of products in an area of expertise;
receiving and storing data evidencing the individual's ownership of or familiarity with products in the area of expertise;
receiving and storing data evidencing the individual's experience in the area of expertise;
receiving and storing indicia of the individual's helpfulness received from one or more persons other than the individual;
utilizing the data evidencing the individual's knowledge of products in the area of expertise, the data evidencing the individual's ownership of or familiarity with products in the area of expertise, the data evidencing the individual's experience in the area of expertise, and the indicia of the individual's helpfulness to generate a score of the individual's influence in the area of expertise; and
using the score of the individual's influence in the area of expertise to match the individual with a person or entity selected from the group consisting of: a manufacturer of products in the area of expertise, a brand of products in the area of expertise, a retailer selling products in the area of expertise, and a consumer seeking guidance or advice in the area of expertise.

2. A non-transitory computer-readable medium as recited in claim 1, wherein generating a score of the individual's influence in the area of expertise comprises applying a decay algorithm to deemphasize a component of the score of the individual's influence of the individual's knowledge, product ownership, experience, or helpfulness as time passes.

3. A non-transitory computer-readable medium as recited in claim 2, wherein the decay algorithm comprises a logarithmic component of decay.

4. A non-transitory computer-readable medium as recited in claim 1, wherein generating a score of the individual's influence in the area of expertise comprises eliminating a component of the score of the individual's influence of the individual's knowledge, product ownership, experience, or helpfulness as time passes.

5. A non-transitory computer-readable medium as recited in claim 1, wherein receiving and storing data evidencing the individual's knowledge of products in the area of expertise comprises:
administering a quiz to test the individual's knowledge of products in the area of expertise;
upon completion of the quiz with a satisfactory score, assigning points toward the score of the individual's influence in the area of expertise based on completion of the quiz.

6. A non-transitory computer-readable medium as recited in claim 1, wherein receiving and storing data evidencing the individual's knowledge of products in the area of expertise comprises:
receiving a selection from the individual indicating a desire to review a training module relating to the products in the area of expertise;
delivering the training module relating to the products in the area of expertise to the individual over a network; and
administering a quiz over the network to confirm that the individual has understood information presented in the training module.

7. A non-transitory computer-readable medium as recited in claim 6, wherein the method further comprises:
receiving information from a third party in the area of expertise;
creating the training module in the area of expertise; and
determining an assignment of training points for the training module in at least the area of expertise to be granted to the individual upon successful completion of the training module.

8. A non-transitory computer-readable medium as recited in claim 7, wherein the method further comprises:
using the computer system to track all users who complete viewing of the training module; and
billing the manufacturer for all instances of completion of the training module.

9. A non-transitory computer-readable medium as recited in claim 1, wherein one or more of the acts of receiving data comprises automatically obtaining data from an external data source over a network, wherein the external data source comprises a source selected from the group consisting of:
a social media account of the individual;
a social media website associated with the individual;
a social media application of the individual;
a global positioning system (GPS) application associated with the individual;
a GPS device associated with the individual;
a fitness tracking application associated with the individual;
a fitness tracking device associated with the individual;
a fitness website containing information relating to the individual;
a website containing a profile of the individual with relevant information;
a website containing information relating to tracking activity of the individual;
a website containing information relating to professional expertise of the individual;
a website or third party providing relevant training to the individual;
a website containing information relating to results of competitive events for the individual;
a purchase history of relevant products for the individual; and
a website or multiple websites with relevant content created by the individual.

10. A non-transitory computer-readable medium as recited in claim 1, wherein the score of the individual's influence in the area of expertise is more heavily weighted toward one or more of the aspects of knowledge of products, ownership of or familiarity with products, experience, and helpfulness.

11. A non-transitory computer-readable medium as recited in claim 1, wherein the score of the individual's influence in the area of expertise is evenly weighted toward all of the aspects of knowledge of products, ownership of or familiarity with products, experience, and helpfulness.

12. A non-transitory computer-readable medium as recited in claim 1, wherein receiving and storing data evidencing the individual's ownership of or familiarity with products in the area of expertise comprises:
receiving an order from the individual to purchase a product through a site operated by the computer system; and
adding the product to a profile of the individual on the computer system.

13. A non-transitory computer-readable medium as recited in claim 1, wherein receiving and storing data evidencing the individual's ownership of or familiarity with products in the area of expertise comprises:
displaying products related to the area of expertise to the individual;
receiving an indication from the individual that the individual owns one of the products displayed to the individual; and
adding the product to a profile of the individual on the computer system.

14. A non-transitory computer-readable medium as recited in claim 1, wherein the method further comprises:
receiving information from the individual to create a profile associated with the individual;
displaying the profile to other users of the computer system while providing an opportunity for the other users to vote the profile up or down; and
receiving and storing one or more up or down votes from the other users, the up or down votes being used to adjust the score of the individual's influence in the area of expertise.

15. A non-transitory computer-readable medium as recited in claim 1, wherein the method further comprises:
receiving information from the individual to create a profile associated with the individual; and
displaying individuals' progress within benchmarks and hierarchies established in the computer system to incentivize participation in the computer system through competitive means.

16. A non-transitory computer-readable medium as recited in claim 1, wherein the method further comprises:
providing a question and answer forum related to the area of expertise;
receiving a question from one or more other users of the computer system relating to the area of expertise;
displaying the question to the individual;
receiving a response to the question from the individual;
displaying the individual's response to one or more other users of the question and answer forum while providing an opportunity for the other users to vote the individual's response up or down; and
receiving and storing one or more up or down votes from the other users, the up or down votes being used to adjust the score of the individual's influence in the area of expertise.

17. A non-transitory computer-readable medium as recited in claim 1, wherein the area of expertise comprises expertise in products of a particular brand, category, or industry.

18. A non-transitory computer-readable medium as recited in claim 1, wherein the method further comprises:
receiving a request from another user of the computer system to identify an expert in the area of expertise; and
using the score of the individual's influence in the area of expertise to identify the individual as an expert in the area of expertise to the other user.

19. A non-transitory computer-readable medium as recited in claim 1, wherein the method further comprises using the score of the individual's influence in the area of expertise to provide an expert locator functionality allowing other users of the computer system to identify individuals geographically local to them with expertise in the area of expertise.

20. A non-transitory computer-readable medium as recited in claim 1, wherein the method further comprises:
notifying manufacturers of products in the area of expertise of the individual's score of the individual's influence; and
providing a communications platform for communications by the manufacturer to the individual.
